(19) United States
(12) Patent Application Publication
(10) Pub. No.: US 2024/0354305 A1
(43) Pub. Date: Oct. 24, 2024

(54) METHOD AND SYSTEM FOR EFFICIENT PARTITIONING AND CONSTRUCTION OF GRAPHS FOR SCALABLE HIGH-PERFORMANCE LONGEST PREFIX MATCHING

(71) Applicant: Altera Corporation, San Jose, CA (US)

(72) Inventor: Mikael SUNDSTRÖM, Lulea (SE)

(21) Appl. No.: 18/751,034

(22) Filed: Jun. 21, 2024

(51) Int. Cl. G06F 16/2455; G06F 16/22

(52) U.S. Cl. CPC G06F 16/24558; G06F 16/2228

(57) ABSTRACT

Methods, apparatus, and systems for efficient partitioning and construction of graphs for scalable high-performance search applications. In one aspect a graph-based method for performing a longest prefix match (LPM) is disclosed. A plurality of ternary keys and created or accessed, each representing an Internet Protocol (IP) mask and having a length w and a number of specific bits comprising a prefix length followed by one or more wildcards. The ternary keys are partitioned into subsets as a function of the prefix lengths of the ternary keys. For each subset, a graph is constructed, and the graph is stored in memory. The graphs are searched for a match for an IP address. A result associated with the graph associated with the subset of prefixed with the longest prefix length is returned. Associated apparatus and systems for implementing the methods are also disclosed. In some embodiments, a graph memory engine (GME) is used.

### BACKGROUND INFORMATION

Search applications generally employ search keys comprising binary and/or ternary keys. A binary key is a bit string where each bit is either 0 (cleared) or 1 (set) and a ternary key is a bit string where each bit is either 0, 1, or * (wildcard, don't care). A pair of keys match if they are of the same size (length, width), and, for each bit position, the bits in the respective keys are either equal or one of the bits is wildcard.

Under a Ternary Match (TM), a search in a table of ternary keys is performed to find the keys that match a given query key. Typically, the query key is a binary key and a winner among the matching ternary keys is selected based on some tie breaking criteria. Applications for (TM) include address lookups in routers (e.g., longest prefix match (LPM)), traffic policing- and filtering in gateways and other appliances (e.g., access control lists (ACL)), and deep packet inspection for security applications.

A Ternary Content Addressable Memories (TCAM) is a hardware device that implements (TM) using a brute force approach wherein ternary keys are stored in registers and the query key is compared to the ternary keys in all registers in parallel to find the matching keys and then the first matching key as winner. TCAMs feature high, deterministic search performance at the cost of extreme power consumption and limited scalability. The largest TCAM devices available in spring of 2023 only scales to a few hundred thousand 480b keys.

Whereas a TCAM provides guaranteed performance independently of the statistical properties of the keys, there are many applications where an algorithmic approach provides sufficient performance with much less overall computing. The extreme example is when there are no wildcards at all in the keys stored in the table. In that case, a simple hashing algorithm yields search performance like TCAM and the amount of computing per search is independent of the table size. Furthermore, a hash table is very simple to scale to higher capacity by just adding more DRAM. TM becomes harder to tackle with an algorithmic approach when there are more wildcards in the ternary keys and when these wildcards are distributed in the keys in a more chaotic fashion.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a graph construction flowchart;

FIG. 2 is a graph constructed from the four keys in TABLE 1;

FIG. 3 shows the top part of the graph consisting of 31 vertices and 32 identical ‘bottom part’ subgraphs illustrated by triangles;

FIG. 4 illustrates one instance of a bottom part subgraph of FIG. 2 consisting of three vertices;

FIG. 5 is a graph supporting partial match search constructed from the keys in TABLE 1;

FIG. 6 is graph resulting from inserting a fifth key in the graph in FIG. 2;

FIG. 6a shows a comparison of the graphs in FIGS. 2 and 6;

FIG. 7 is a flowchart illustrating operations for determining a longest prefix match, according to one embodiment;

FIG. 8 is a flowchart illustrating operations for performing a prefix length partition using a cost function, according to one embodiment;

FIG. 9 shows a table of four prefixes and four graphs constructed from these prefixes using an example prefix length partition, according to one embodiment;

FIG. 10A is a functional block diagram of a graph memory engine using associative memory, according to one or more embodiments.

FIG. 10B is a functional block diagram of a Turing-compatible computation engine sourcing instructions from a graph memory engine, according to one or more embodiments.

FIG. 11 is schematic block diagram of a graph memory engine utilizing associative memory, according to one or more embodiments.

FIG. 12 is a diagram of a computing system on which aspects of the embodiments may be implemented, according to one embodiment;

FIG. 13 is a block diagram of a packet processing apparatus, according to one embodiment;

FIG. 14A is a diagram illustrating an Infrastructure Processing Unit, according to one embodiment;

FIG. 14B is a diagram illustrating an Infrastructure Processing Unit, according to a second embodiment;

FIG. 15 is a diagram illustrating a SmartNIC, according to one embodiment; and

FIG. 16 is a diagram of a switch configured with circuitry and logic for implementing aspects of the embodiments disclosed herein.

### DETAILED DESCRIPTION

Embodiments of methods, apparatus, and systems for efficient partitioning and construction of graphs for scalable high-performance search applications are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments disclosed herein, methods and associated algorithms and systems for efficiently partitioning and constructing graphs for scalable high-performance longest prefix matching (LPM) are provided. In one aspect, an algorithmic approach may take advantage from partitioning the set of keys such that sets of ternary keys with considerably different structure are stored in different tables and that search is directed to the appropriate table based on the state of execution in the device running the TM algorithm. Furthermore, whereas hashing requires only a single thread of execution and TCAM requires, at least conceptually, one thread of execution per ternary key in the table, the disclosed solution implements an architecture where the table is partitioned into sub-tables, where each sub-table is represented as a sub-graph, and a fixed number of execution threads performs search in parallel in the respective sub-graphs.

The solution addresses the TM application for LPM where specified bits are located in the most significant bits of keys and wildcards are located in the least significant bits. Such keys are referred to as prefixes and the number of specified bits is referred to as the length of the prefix. Whereas the tie-breaking criteria can be an arbitrary rule priority in ACL (access control list) style applications, the priority in LPM is tied to the prefix length such that longer prefixes have higher priority.

Embodiments of the solution feature a method of partitioning sets of prefixes into an optimal partition of subsets, for a given partition size, based on the prefix length distribution, as well as constructing graphs wherein lookup in each graph only requires processing of a single graph node.

In other aspects, single node space (memory) optimal graphs are constructed and maintained. Each graph is associated with a prefix length interval, constituting a subset of a partition of the prefix length space. The graphs are searched sequentially, in parallel, or a combination thereof, followed by returning the result associated with the (single) match from the graph associated with the subset of prefixes with the longest prefix length. The number of graphs may be chosen with respect to tradeoff in target lookup performance, capabilities in parallel processing, and other factors related to the hardware platform where the lookup is executed. Given the number of graphs and the target (or expected) statistical prefix length distribution, a partition of the prefix length space that yields optimal memory utilization, for any set of prefixes where the prefix lengths match the target distribution, is computed.

### Bits, Keys, and Graphs

A ‘binary bit’ is either ‘false’ or ‘true’, denoted by 0 and 1, respectively, whereas a ‘ternary bit’, can also be ‘wildcard’, or ‘don't care’, denoted by the asterisk operator *. A pair of bits x and y ‘matches’, denoted by x≅y, if x=y, x=*, or y=*. A pair of bits x and y that do not match are said to ‘mismatch’, denoted by x [symbol] y.

Note that the relationship operators ‘=’ and ‘≠’ mean ‘equal to’ and ‘not equal to’ according to the standard definition of equality. For example, for bits 0=0, 1=1,*=*, 0≠1, 0≠*, 1≠* etc.

A w-bit ‘key’ X, is an array x₁x₂ . . . x_{w} where each xᵢ is a binary- or ternary bit. A pair of keys X=x₁x₂ . . . x_{w} and Y=y₁y₂ . . . y_{w} ‘matches’, denoted by X≅Y, if xᵢ≅yᵢ for all i=1, 2, . . . , w. A pair of keys X and Y that do not match are said to ‘mismatch’, denoted by X [symbol] Y.

The overall purpose of a graph, in the context of the present invention, is to represent a set of n w-bit keys K={K₁, K₂, . . . , Kₙ} such that, given a query key K the graph can be ‘searched’ to efficiently compute a subset K′ of K, such that, for any key K′∈K′|K≅K′.

TABLE 1

| Key | Data | 12345678 |
|---|---|---|
| K₁ | D₁ | 00101*** |
| K₂ | D₂ | 00*0001* |
| K₃ | D₃ | 1**10011 |
| K₄ | D₄ | ***11*** |

TABLE 1 shows a set of four ternary 8-bit ternary keys K₁, . . . , K₄ with corresponding data D₁, . . . , D₄. The rightmost column shows the individual ternary bits of the keys at the respective bit positions 1 . . . 8 shown in the header. Note that fixed-width font is used to describe bit arrays since it makes it easier to view keys on top of each other and notice similarities and differences. These four keys are easy to distinguish from each other since each key has a unique value in bit positions 4 . . . 5.

Data graphs of nodes and associated data are stored in an associative array. Therefore, addresses or pointers are not required to locate data and code in memory to be executed, e.g., for a next graph node. Instead, a next instruction at a next node in the graph is fetched by starting with a current state ‘Node ID’. Combining it with the results of a ‘computation’ (e.g., a simple calculation, computation test, bit retrieval and concatenating, hash value computation etc.), to create a ‘new search key’, and then using the new search key to access the associative array for a match to the next node, or instruction, in the graph. This process is also termed ‘in-graph computing’.

Since the purpose of the computation mentioned in the previous section, is to determine which outgoing edge to follow, we refer to the resulting values and keys from such computations as ‘edge values’ and ‘edge keys’, respectively. Thus, in principle, each node in the graph is constituted by a Node ID and a ‘method’ for edge key retrieval whereas each edge is constituted by a (Node ID, edge value), where Node ID refers to the origin node of the edge, pair which is looked up in the associative memory to obtain the target node reached by traversing the edge.

When the keys stored in the graph are fully specified binary keys, e.g., represented by array of bits where each bit is either 0 or 1, edge key retrieval is straight forward. However, when dealing with ternary binary keys represented by array of bits where each bit is either 0, 1 or *, where * represents ‘wildcard’ or ‘don't care’, edge key retrieval becomes more intricate since inclusion of wildcards bits during edge key retrieval result in several edge values as opposed to a unique edge value. The reason for this is that edge values resulting from all possible assignments of 0 and 1 to wildcard bits must be considered and each such assignment potentially results in a unique edge value. For each such edge value the key must be stored in the subgraph reachable through the edge corresponding to said edge value and the key is thus ‘replicated’ across multiple subgraphs.

For some sets of ternary keys, it is not possible to achieve wildcard free edge key retrieval. It may then be better to partition the set of keys in subsets where wildcard free edge key retrieval can be achieved, or at least inclusion of wildcards bits in edge key retrieval can be minimized, for each subset. This process is referred to as ‘Partitioning’ and the overall purpose is to achieve one graph per subset that can be efficiently represented rather than a single graph that is inefficiently represented.

‘Construction’ refers to the process of building either an entire graph from scratch or re-constructing a sub-graph from a set of keys represented by ternary bit strings. Each key may further be associated with a ‘priority’ and/or a piece of ‘information’.

‘Search’ refers to the process of starting at a given node, which is typically a/the ‘root’ and locating all reachable keys stored in the graph that ‘matches’ a given ‘query key’. There are two kinds of searches and corresponding matches, ‘full match’ and ‘partial match’, and the graph is constructed according to the kind of search to be supported.

Full match means that for each specified bit in the query key the corresponding bit in the matching key stored in the graph is either equal or wildcard. The result from full match search is thus a set of keys guaranteed to match the query key.

Partial match is related to ‘irreducibility’ of sets of keys. A set of keys K={K₁, K₂, . . . }, is said to be ‘irreducible’ if, for any pair of keys Kᵢ and Kⱼ in K, Kᵢ≅Kⱼ. Any set of keys not irreducible is said to be ‘reducible’. To support partial match, it is sufficient to construct the graph until the remaining set of keys is irreducible. The result from partial match is thus a set of keys that ‘may’ match the query key but needs to be further processed to confirm actual matches and remove false positives.

Another dimension of search is how many results that are produced. Full match search can either be ‘full single match’ or ‘full multi match’. Full single match means that the best (according to some tie breaking criteria such as priority etc.) matching key is returned whereas full multi match search means that all matching keys are returned. Hybrids where a limited, according to some threshold, number of best matching keys (again selected according to some tie breaking criteria) are returned as result are also possible. Partial match search is always performed as partial multi match search.

For computer networking applications the query key is often fully specified with no wildcard bits. However, there are also applications where query keys contain one or more wildcard bits.

A directed graph with a single root and wherein each node (except the root) is only reachable from one ‘parent’ node is called a ‘tree’. In a tree, each node reachable from a given parent node is called a ‘child’ of the parent node. Furthermore, the set of nodes including the parent, the grandparent, the great grandparent, and so on until the root, of a node in a tree is the set of ‘ascendants’ of the node and the set of all nodes reachable from the node is the ‘descendants’ of that node. A node without children (no outgoing edges) is referred to as a ‘leaf’.

A directed graph with one or more roots but without ‘cycles’, e.g., without node-edge chains that leads back to the origin, is called a ‘directed acyclic graph’ or ‘DAG’ for short. The terms parent, child, ascendant, and descendant also apply to DAGs noting that a node may have several parents.

While there are applications for more general graphs that contain cycles, the child-parent relationship in such graphs is generally not well defined (since a node may be its own parent/ancestor). In such graphs, a more sophisticated computation of edge keys involving some state may also be required to ensure that searches are terminating.

The definitions of nodes and leaves described herein refer to graphs in general and do not directly translate to in-graph computing in the context of the present disclosure. This is partly due to the actual graphs constructed are not graphs that represent—and operate on keys but rather graphs that represent—and operate on individual bits and selection of bits in keys. An analogy: whereas comparison-based search trees data structures for representing text strings operate on entire strings, ‘Trie’ data structures for representing text strings operate on individual characters (or even individual bits in characters). The toolbox of constructs available in the graph memory engine of the present invention allows for representation- and operation on keys at the bit level, e.g., in the same way as a Trie operates on text strings.

To distinguish between graphs and their constructs, in general, and the corresponding building blocks available in a graph memory engine, nodes and edges in the graph memory engine are referred to as ‘vertices’ (singular: “vertex’) and ‘arcs’ (singular: ‘arc’), respectively.

A ‘label’ is a non-negative integer value.

A ‘map’ is a function that retrieves bit values from a key and compute a ‘label’ from these bit values. If the bit values retrieved from the key include wildcard bits, labels according to all possible 0/1 assignments of wildcard bits are computed thus yielding a set of labels rather than a single label.

A ‘data map’ δ is a function that map a key K to sets of ‘data labels’ δ(K).

An ‘arc map’ is a function that map a key K to sets of ‘arc labels’ α(K).

A ‘vertex’ consists of ‘labeled data’ and ‘labeled arcs’.

‘Labeled data’, or simply ‘data’, is collection of data where each piece of data Dₐ is associated with a ‘data label’ α. Data constitute results of search and is output when visiting the vertex during search if certain criteria (such as matching label) is met.

‘Labeled arcs’, or simply ‘arcs’, is a collection of arcs where each arc A_{α} is associated with an ‘arc label’ α. Arcs constitute the path that binds the graph together and are traversed during search if certain criteria (e.g., matching label) are met.

An ‘arc’ consists of a ‘data map’, an ‘arc map’, and a target ‘vertex’. If the data map and/or arc map of all arcs leading to a particular target vertex are equivalent (e.g., identical) the respective map, or both maps, can be part of the target vertex, yielding a vertex that, in addition to labeled data and labeled arcs, also consists of a data map and an arc map, instead of being part of each of the arcs leading to said target vertex.

Vertices and arcs relate to the previous discussion about nodes, edges and edge key retrieval as follows. An arc label corresponds to an edge key value and the arc map corresponds to edge key retrieval. Moreover, a vertex corresponds to a node and the Node ID, as well, since there is nothing to gain from introducing a special vertex ID. A vertex is combined with an arc label, obtained by applying the arc map of the vertex to the key, to obtain an ‘arc key’, which corresponds to the new search key mentioned above. The arc key is looked up in the associative array to obtain an arc. All arcs leading from a vertex are stored in the associative array with a key that is partly constructed from said vertex and are thus associated with said vertex.

In addition to the above, vertices are also associated with data that is output during search. Such data constitute the result of search and may contain identifiers of which keys are matched, actions to be executed and other information, or may represent a simple index into a table containing arbitrary information, actions, etc. A vertex is combined with a data label, obtained by applying the data map of the vertex to the key, to obtain a ‘data key’. The data key is looked up in the associative array to obtain a piece of data. All pieces of data associated with a vertex are stored in the associative array with a key that is partly constructed from said vertex.

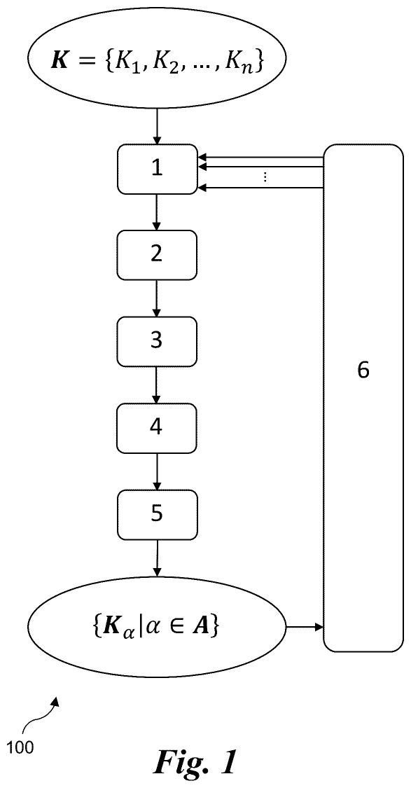

FIG. 1 shows a graph construction flowchart 100. On a high level, construction of a (sub)graph, to represent a set of keys K={K₁, K₂, . . . , Kₙ} is a recursive process wherein a vertex and the arc leading to said vertex is constructed at each level in the recursion.

The first operation, in each level in the recursion, is to ‘analyze’ the set of keys K to compute efficient (e.g., ideally optimal) map functions, ‘data map’ and ‘arc map’, respectively.

The second operation, in each level in the recursion, is to compute the set of data labels Dᵢ, for each Kᵢ∈K, followed by computing the set of all data labels D=Uᵢ₌₁ⁿ Dᵢ.

The third operation, in each level in the recursion, is to construct the data to be associated with each data label and associate the ‘data label to data’ mapping with the vertex.

The fourth operation, in each level in the recursion, is to compute a set of arc labels Aᵢ, for each Kᵢ∈K, followed by computing the set of all arc labels A=Uᵢ₌₁ⁿ Aᵢ.

The fifth operation, in each level in the recursion, is to construct a set of keys K_{α}, for each arc label α∈A, where Kᵢ∈K_{α} if and only if α∈Aᵢ. Note that {K_{α}|α∈A} is typically not a partition of K but it can be.

The sixth operation, in each level in the recursion, is to recursively construct subgraphs associated with each arc label and associate each subgraph, represented by the arc leading to said subgraph, with the corresponding arc label and associate the ‘arc label to arc’ mapping with the vertex. More precisely, for each α∈Aᵢ, an ‘α specified subgraph’, or simply ‘α-subgraph’, is recursively constructed from K_{α} and the arc leading to said subgraph is associated with the arc label α.

As mentioned above, there are different kinds of searches and depending on which kind of search to support the graph can be constructed differently.

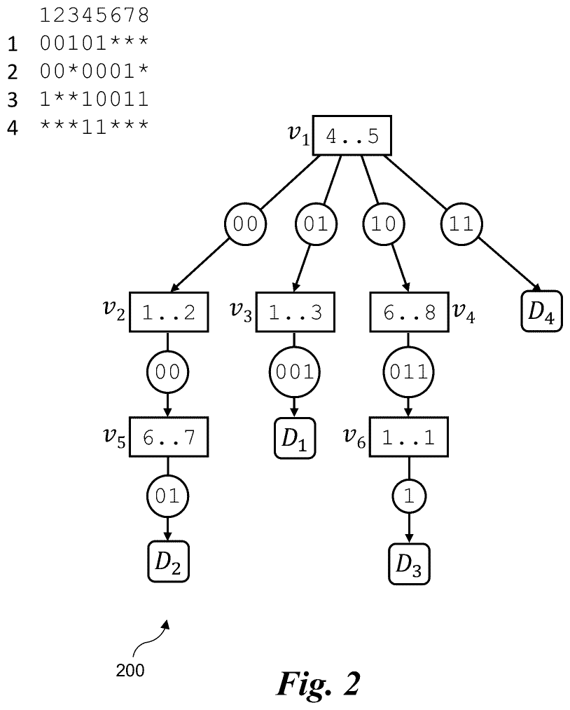

FIG. 2 shows a graph constructed from the four keys in TABLE 1. Vertices consist of data- and arc maps and are shown as rectangles with start bit position and end bit position of retrieval. Data and arc labels are shown as circles containing the arc label in base two, and output data are shown in rectangles with rounded corners containing the respective piece of data.

The graph of FIG. 2 supports full single match search as well as full multiple match search. The graph consists of 6 vertices v₁, . . . , v₆, where v₁, is the root vertex. The arc map of v, retrieves bits 4 . . . 5 of the query key yielding four different arc labels 0=00_{b}, 1=01_{b}, 2=10_{b}, and 3=11_{b}. The four keys all have different values in bits 4 . . . 5 and, as a result, the choice of arc map in the root vertex partitions the input without causing any replication. Arc label 00_{b} is associated with an arc leading to vertex v₂ where the only possible matching key is K₂ with associated data D₂. In v₂ the next pair of specified bits 1 . . . 2 in K₂ are checked and the arc label 00_{b}, which is the only available arc label, leads to vertex v₅. Note that v₅ does not have any outgoing arcs. In v₅ the remaining two bits at location/position 6 . . . 7 are checked. If bits 6 . . . 7 matches the data label 00_{b} in vertex v₅, all specified bits of the key have been matched and the data D₂ associated with the data label 00_{b} is output. Similarly, arc labels 01_{b} and 10_{b} of the root vertex leads to subgraphs where the remaining bits of keys K₂ and K₃ are matched, respectively. Since only bits 4 . . . 5 of K₄ are specified, the root vertex has a data label 11_{b} with associated output data D₄ that is output as K₄ is matched.

TABLE 2

| Associative Memory Input | | | Associative Memory Output | | | |
|---|---|---|---|---|---|---|
| Vertex | Data labeL | Arc label | Data | Vertex | Data Map | Arc Map |
| | | | | ν₁ | 4 . . . 5 | 4 . . . 5 |
| ν₁ | | 00_{b} | | ν₂ | | 1 . . . 2 |
| ν₁ | | 01_{b} | | ν₃ | 1 . . . 3 | |
| ν₁ | | 10_{b} | | ν₄ | | 6 . . . 8 |
| ν₁ | 11_{b} | | D₄ | | | |
| ν₂ | | 00_{b} | | ν₅ | 6 . . . 7 | |
| ν₃ | 001_{b} | | D₁ | | | |
| ν₄ | | 011_{b} | | ν₆ | 1 . . . 1 | |
| ν₅ | 01_{b} | | D₂ | | | |
| ν₆ | 1_{b} | | D₃ | | | |

The content of the associative memory for the graph in FIG. 2 is shown in TABLE 2. Associative memory input (v, δ, α) is represented by a source vertex v, a data label δ, and an arc label α, whereas associative memory output (D, v, δ, α) is represented by a piece of data D, a destination vertex v, a data map δ and an arc map α. Note that there is no key (Associative Memory Input) for the root vertex as it is represented by the associative memory output (−, v₁, 4 . . . 5, 4 . . . 5), where ‘−’ denotes omitted input/output.

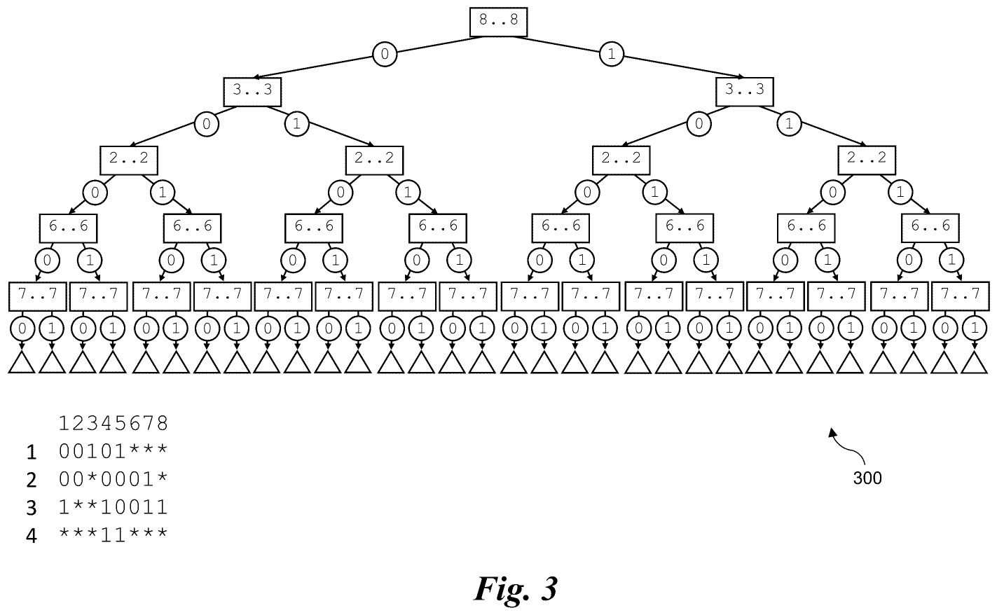

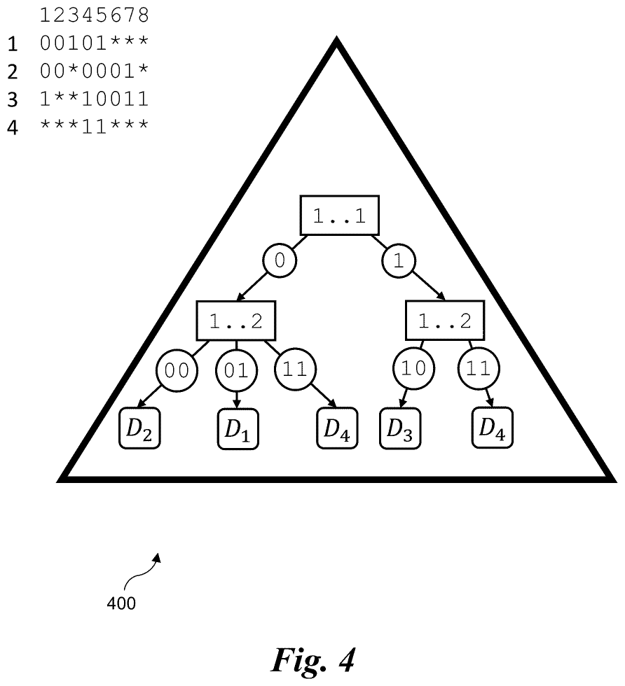

In the brief description of recursive graph construction above, the purpose of one operation at each level in the recursion is computation of efficient maps, in particular arc maps. FIGS. 3 and 4 shows a graph, supporting full single match search and full multiple match search constructed, from the keys in TABLE 1 using the ‘worst possible’ arc map functions at each level. FIG. 3 shows the top part of the graph consisting of 31 vertices and 32 identical ‘bottom part’ subgraphs illustrated by triangles. FIG. 4 illustrates one instance of a bottom part subgraph consisting of three vertices. In total, the graph constructed using inefficient arc maps consists of 127 vertices to be compared with the graph constructed using efficient arc maps which consists of only six vertices. Furthermore, the depth, measured in maximum number of arcs traversed to reach from the root vertex to a terminating vertex, is six in the graph constructed using inefficient arc maps and two in the graph constructed using efficient arc maps (bottom arrow is not counted as an arc since it refers to data). This example and comparison clearly show the importance of computing efficient arc map functions to achieve efficient graph representation.

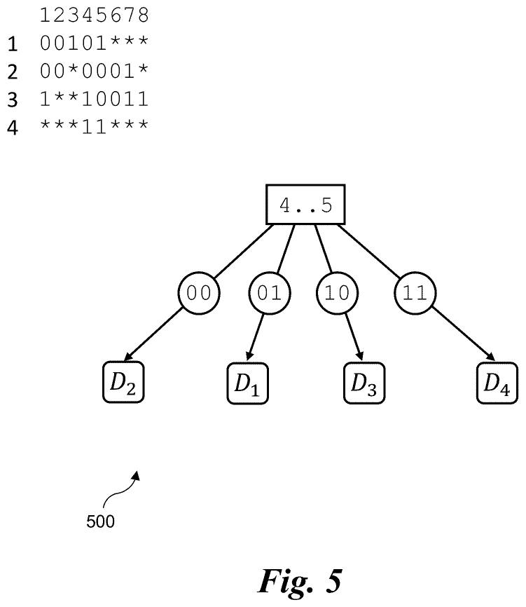

FIG. 5 shows a graph supporting partial match search constructed from the keys in TABLE 1. Note that since only partial match search is supported not all bits of the keys are matched. It is sufficient to match enough bits to be able to discriminate keys from each other and obtain irreducible subsets (a set of one key is obviously irreducible).

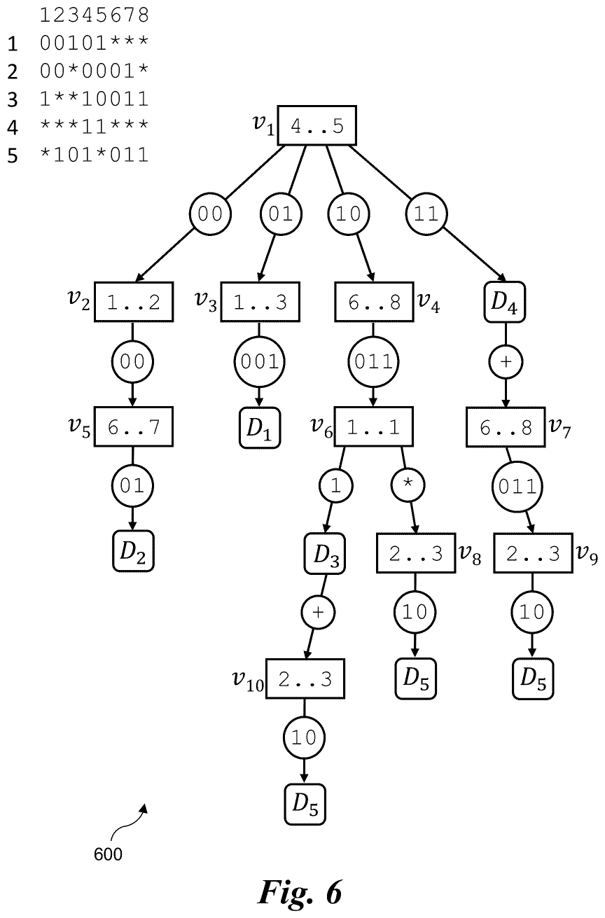

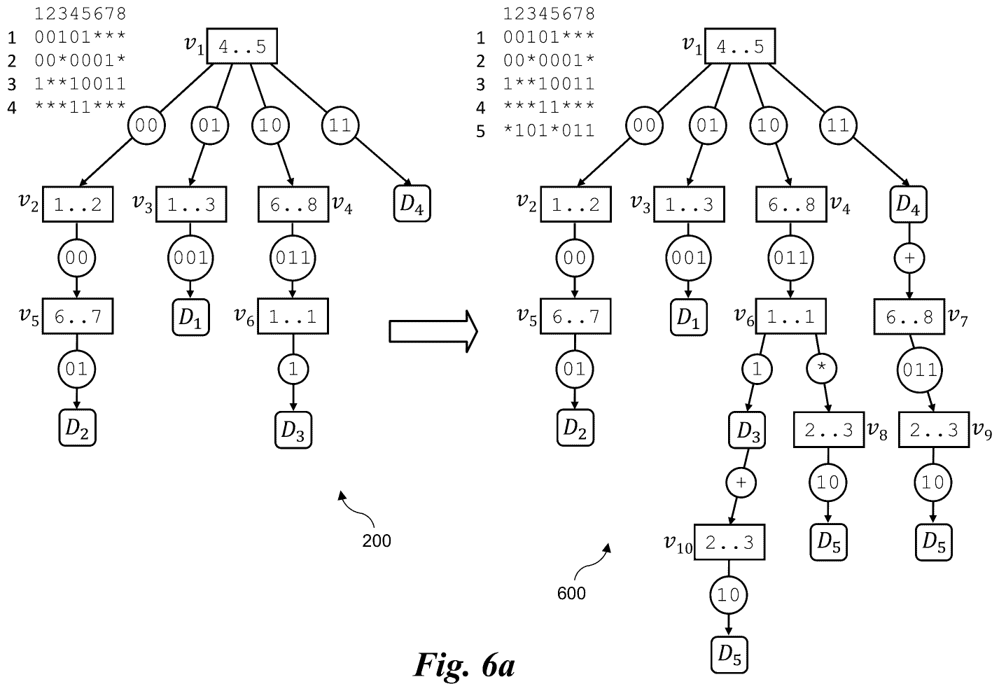

FIG. 6 shows a graph 600 resulting from inserting a fifth key in graph 200 in FIG. 2, while FIG. 6a shows a comparison between graphs 200 and 600. This results in new vertexes v₇, v₈, v₉, and v₁₀ being added, as follows. Vertex v₆ retrieves bits 1 . . . 1, as before, which now yields two arc labels 1 and * rather than just a single arc label 1. Arc label 1 leads to data D₃, as before, but further leads to vertex v₁₀. The arc map of v₁₀ retrieves bits 2 . . . 3, which has an arc label 10b, where all specified bits of the key K₅ have been matched resulting in a first instance of data D₅. Arc label * from vertex v₆ leads to vertex v₈. The arc map of v₈ retrieves bits 2 . . . 3 of the query key yielding arc label 10_{b}, where, as above, all specified bits of the key K₅ have been matched resulting in a second instance of data D₅. Vertex v₇ is added to data D₄, and has an arc map that retrieves bits 6 . . . 8 of the query key yielding arc label 011_{b}, which yields vertex v₉. The arc map of v₉ retrieves bits 2 . . . 3 of the query key yielding arc label 10_{b}, where all specified bits of the key have been matched for a third time and a third instance of data D₅ associated with the data label 10_{b} is output.

This concludes the high-level description of graph memory engine graph constructs and construction covering only specified arcs and corresponding subgraphs. There are also ‘unspecified’ and ‘mandatory’ arcs and subgraphs, respectively, and these are described in detail below. In what follows, partitioning of input set into subsets to specifically designed for Longest Prefix Matching is described in more detail.

### Graph Construction

There are several different kinds of arcs and corresponding arc labels. A ‘specified arc’ is an arc corresponding to a ‘specified arc label’. All arcs and arc labels described above are specified arcs. An arc A_{α} with the label α is referred to a α-arc and the corresponding subgraph, reached by traversing the arc A_{α}, is referred to as an α-subgraph.

An ‘unspecified arc’, or ‘*-arc’, is an arc corresponding to all ‘unspecified arc labels’, that is all arc labels that (for whatever reason) are not included in the set of specified arc labels. It is possible, during construction of a vertex, to only consider a subset of A as specified arc labels and treat the rest as unspecified arc labels. Other examples of unspecified arc labels are during search when the arc label, obtained from computing the arc map of the query key in a vertex, does not match any of the specified arc labels in the vertex. The subgraph reached via an *-arc is referred to as ‘unspecified subgraph’ or ‘*-subgraph’.

A ‘mandatory arc’, or ‘+-arc, is an arc without an arc label that must always be traversed during search independently of whether the arc label of the query key is equal to a specified- or unspecified arc label or not. Note that search will typically branch out across multiple paths at vertices with mandatory arcs even if the query key is fully specified. The subgraph reached via a +-arc is referred to as ‘mandatory subgraph’ or ‘+-subgraph’.

As with arcs, there are also different kinds of data. A piece of specified data is a piece of data corresponding to a ‘specified data label’. A piece of data D_{α} associated with data label α is referred to as α-data and is output, during search, when visiting the vertex if the data label α is computed from the query key. A piece of ‘unspecified data’, denoted by D_{*}, is a piece of data that is output, during search, if the data label computed from the key is not equal to any of the specified data labels of the vertex. Unspecified data may—or may not be present in the vertex. A piece of ‘mandatory data’, denoted by D+, is a piece of data that is always output, during search, when visiting the vertex containing mandatory data. Mandatory data may—or may not be present in a vertex.

A vertex with at least two specified arc labels is called a ‘branching vertex’ and a vertex with less than two specified arc labels is called a ‘non-branching vertex’.

Before describing the construction of vertices in more detail the different scenarios of terminating subgraphs are next described.

There are three different variants of terminating a graph depending on which kind of search to support. To support ‘full multi match’ search, chains of all possibly matching vertices that represent all non-wildcard bits of individual keys must be created to ensure that all specified keys are matched before concluding that the keys match (and returning the data/information associated recorded in vertices) whereas for ‘partial match’ search it is sufficient terminate the graph when the set of keys to construct the subgraph from is irreducible.

Construction of a graph supporting full single- or multi match search from a single key K associated with output data D is achieved as follows. Find the longest sequence of specified bits in K and extract as label λ. Clone K to K′ and set all the extracted bits in K′ to wildcard. If the entire K′ is wildcard, complete the construction by storing (λ, D) as key-data pair, e.g., D_{λ}=D, in the current vertex. Otherwise, construct a λ-subgraph A_{λ} from K′ and complete the construction by storing (λ, A_{λ}) as key-arc pair in the current vertex.

Construction of a graph supporting full single match search from an irreducible set of keys K is achieved by selecting one key K (e.g., the highest priority key if the keys have priority) and construct a subgraph root vertex as if it is a single key, with the following modification. Instead of recursively constructing an λ-subgraph from K, an λ-subgraph A_{λ} is constructed from K′, which is constructed by cloning each key in K and setting all extracted bits in the key to wildcard in the same way K′ is constructed from K. Furthermore, a *-subgraph is constructed from K′\{K′}.

Construction of a graph, where each vertex can hold a single piece of data, supporting partial match search from an irreducible set of keys K is achieved by selecting one key K associated with output data D, as in the single match case, and store D as mandatory data D₊=D in the vertex. This is followed by recursively constructing a *-subgraph from K\{K}.

Construction of a graph, where each vertex can hold either a restricted- or an arbitrary number of pieces of data, supporting partial match search from an irreducible set of keys K with associated pieces of data D is achieved by simply storing D as mandatory data D₊=D in the vertex.

Consider construction of a vertex from a set of keys K, and focus on the selection of specified arc labels S, and unspecified arc labels U, from the set of arc labels A (note that {S, U} is a partition of A).

One approach is to select S=A. This means that all arc labels are considered specified arc labels and only those not obtained from any of the keys are considered unspecified. This approach works quite well if there are none, or at least very few, wildcards among the bits retrieved during arc map computation. Keys where many bits are retrieved during arc map computation are likely to yield many arc labels and are thus heavily replicated. An advantage of this approach is that it maximizes the vertex fan-out and may therefore yield a shallower graph.

Another approach is to select a subset of A. Let E be a subset of A consisting of all arc labels obtained from keys where no wildcard bits are retrieved (and assigned) and I be a subset of A of all arc labels obtained from keys where at least one wildcard bit is retrieved (and assigned), during arc map computation. Clearly, |A|≤|E|+|I|.

Now let S=E\I, where denotes ‘set difference’. Choosing S yields a set of sets of keys {K_{σ}|σ∈S} which is a partition of the set U_{σ∈S}K_{σ}, thus achieving zero replication. However, all keys that contain wildcards among the retrieved bits will be used in the recursive construction of the ‘unspecified subgraph’. If there are many such keys, the number of keys in the unspecified subgraph may be almost the same as the number of keys to start with, when constructing the vertex, and the vertex may thus be slightly inefficient. An arc label present in the set S, constructed as described in this section, is referred to as an ‘explicit arc label’. Any other arc label is referred to as ‘implicit arc label’.

Yet another approach, which is a middle-way between the two extremes described above, is to let S=E. By this approach, all arc labels that are ‘explicitly’, e.g., without wildcard bit retrieval and assignment, obtained by arc map computations constitute specified arc labels. Some of the keys that yield ‘implicit’, e.g., involving wildcard retrieval and assignment, arc labels are also treated as specified and will be replicated.

There are several optimization criteria that may be considered when constructing a graph. Examples of such optimization criteria include minimizing the number of branching vertices, minimizing the number non-branching vertices, and minimizing the number of arcs. In the graph memory model arcs correspond to vertices and an efficient representation minimizes the search time by minimizing the number of arcs traversed during search and the graph space (memory) by minimizing the overall number of arcs.

In the simplest possible embodiment, suitable for applications where the keys stored in the graph are fully specified, only specified arcs are required. Let k be the maximum number of bits that can be retrieved during data- and arc map computations. By selecting the k bits that maximizes |A|, the number of arcs, from a given vertex, is maximized and the depth of the graph is minimized. Since the keys are wildcard free each key is only stored in exactly one subgraph of each vertex thus no replication occurs.

In an alternative embodiment, also suitable for applications where the keys stored in the graph are fully specified, both specified- and unspecified arcs are used. In such an embodiment the main reason for using unspecified arcs instead of several specified arcs is to consolidate subsets of keys that are small compared to other subsets of keys. For example, if there are three sets of keys with five keys in each with three corresponding specified arc labels α₁, α₂, α₃, and five single key sets with corresponding arc labels α₄, α₅, α₆, α₇, α₈, the last five single key subsets can be consolidated into one and stored in the subgraph reached via the unspecified arc. In this way, all four subgraphs will contain five keys.

In yet another alternative embodiment, suitable for applications where the keys stored in the graph contains wildcards, only specified- and unspecified arcs are used. In such an embodiment, the set S contains only explicit arc labels and the keys from which these arc labels are obtained are stored in the corresponding subgraphs whereas all keys from which implicit arc labels are obtained are stored in the unspecified subgraph.

In yet another alternative embodiment, suitable for applications where the keys stored in the graph contain wildcards, only specified- and mandatory arcs are used. In such an embodiment, specified arc labels may or may not include implicit arc labels whereas keys with implicit arc labels are stored in the mandatory subgraph. If all specified arcs labels are explicit arc labels no replication occurs and the vertex is optimal, with respect to the chosen method of arc map computation, from a space (memory, storage) perspective.

In yet another alternative embodiment, suitable for applications where the keys stored in the graph contain wildcards, both specified, unspecified, and mandatory arcs are used. In such embodiments, keys with implicit arc labels are preferably stored in the mandatory subgraph to minimize replication whereas some keys with explicit arc labels may be stored in the unspecified subgraph to balance the number of keys between subgraphs.

In an alternative embodiment, suitable for applications where the keys stored in the graph contain wildcards, the set of specified arc labels is a subset of the arc labels that can be obtained from the keys when considering all possible assignments of wildcard bits retrieved from the keys. If, in a vertex produced in such an embodiment, the set of specified arc labels is identical to the set of obtained arc labels a mandatory arc is not required and, consequently, the mandatory subgraph does not exist (or is empty). Otherwise, a mandatory arc is required and all keys producing one or more arc labels not in the set of specified arc labels must be stored in the mandatory subgraph. Otherwise, any arc label missing from the set of specified arc labels is considered either unspecified or mandatory and the key associated with such an arc label is stored in the corresponding unspecified- or mandatory subgraph and any key associated with one or more specified arc labels is replicated and stored in each of the corresponding subgraphs. In such an embodiment, only keys with arc labels that do not match any of the specified arc labels are stored in the unspecified subgraph.

Data and data map computation have been described in the context of vertices where the method is the same independently of how a search arrives at the vertex. In alternative embodiments, targeted for specific applications where a cyclic graph is used, the data map computation method may be associated with the arc leading to the vertex so that different methods are used depending on how the search arrives at the vertex.

Arcs and arc map computation have been described in the context of vertices where the method is the same independently of how a search arrives at the vertex. In alternative embodiments, targeted for specific applications where a cyclic graph is used, the arc map computation method may be associated with the arc leading to the vertex so that different methods are used depending on how the search arrives at the vertex.

An important part of the vertex construction of a graph is to is to determine the method of retrieval of bits from keys, ‘bit retrieval, and arc map computation in each vertex. There are four main approaches to bit retrieval: (i) ‘single bit retrieval’ where a single bit is retrieved and its value constitutes a 1-bit arc label, (ii) ‘multiple bit retrieval’ where a number k of adjacent bits are retrieved and their value, interpreted as a non-negative integer, constitutes a k-bit arc label, (iii) ‘scattered bit retrieval’ where a number k of scattered bits are retrieved, and concatenated, and their value, interpreted as a non-negative integer, constitutes a k-bit arc label, and (iv) ‘scattered bit computation’ where an arbitrary number of scattered bits are retrieved and some form of computation (e.g., computation of hash, counting number of 0s, etc.) is performed on the retrieved bits yielding a k-bit non-negative integer that constitute the arc label.

In an embodiment where single bit retrieval is used the arc map computation method only retrieves a single bit yielding 1-bit arc labels. In a vertex where a single bit is retrieved there is no need for unspecified subgraphs and only a 0-arc and a 1-arc is required. A +-arc for keys where the extracted bit is wildcard may also be used to minimize replication at the cost of search performance (space vs. time trade-off).

In another single bit retrieval embodiment, the bit to retrieve in a vertex increases with the distance of the vertex from the root such that bit 0 is retrieved in the root, bit 1 is retrieved in each of the two (or three if there is a mandatory arc) children of the root, and so on.

In an alternative single bit retrieval embodiment where keys are inserted in the graph on-the-fly (e.g., the graph is dynamically updated rather than being built/rebuilt from scratch), a ‘new key’ is inserted by traversing the graph starting from the root, noting that traversal branches, recursively until a non-branching vertex is encountered. The subgraph where the non-branching vertex is the root is referred to as ‘old subgraph’. Then a ‘new subgraph’ is constructed from all keys in the encountered old subgraph and the new key and the old subgraph is replaced by the new subgraph. In such an embodiment, subgraphs may be inefficiently stored due to the order of which keys arrive and needs to be regularly optimized and reconstructed. This is achieved by partial reconstruction of the corresponding subgraphs and described in detail in the context of ‘incremental update’ of graphs.

In yet an alternative embodiment, referred to as a ‘quantum key based single bit retrieval’ embodiment, a quantum key representing the n keys is constructed and the optimal bit to retrieve is selected based on minimizing cost according to a cost function that for a given bit index i compute the cost for selecting that bit from n and q₁=(nᵢ₀, nᵢ₁, n_{i*}). Such cost functions typically yield high costs for bit indexes i where n_{i*}, is large and the difference between nᵢ₀ and nᵢ₁ is large, and small costs for bit indexes where nᵢ₀≈nᵢ₁and n_{i*} is small −nᵢ₀=nᵢ₁=n/2 and n_{i*}=0 being the ideal.

In a basic multiple bit retrieval embodiment, the most significant first t₀ bits of the keys are selected in the root vertex, the next t₁ most significant bits are selected in each vertex being a child of the root, and so on until the last tₜ₋₁ bits are selected in the leaves. The resulting graph from such an embodiment is called t₀, t₁, . . . , tₜ₋₁ ‘variable stride trie’ and is commonly used to perform longest prefix matching (LPM).

In an alternative embodiment, referred to as a ‘quantum key based multiple bit retrieval’ embodiment, a quantum key is constructed and the optimal sequence of bits to retrieve is selected based on minimizing a cost according to a cost function that for a given start bit index f and an end bit index t compute a cost from the number of keys n and q_{f}, q_{f+1}, . . . , qₜ₋₁, qₜ.

The optimization criteria in quantum key based multiple bit retrieval is essentially the same as for quantum key based single bit retrieval in that sequences of bit indices where there are lots of wildcards should be avoided and a balance between the number of keys ending up in each subgraph (noting that 2^{t-f+1} children is possibly required compared to two to three for quantum key based single bit retrieval). The advantage of quantum key based multiple bit retrieval compared to quantum key based single bit retrieval is that a larger number of bits yields more children (subgraphs) which enables a more efficient reduction of matching key candidates in each vertex and thus a shallower graph featuring faster search. However, the drawback is that replication of keys may increase a lot when several bits are inspected especially if the sequence of bit indices is not carefully chosen.

In a preferred quantum key based multiple bit retrieval embodiment the ‘composite cost’, for selecting a ‘sequence’ f . . . t of multiple adjacent bit indices starting with f and ending with t, is computed as follows. First a base β is computed as β=max(N, 2^{ω})+1, where N is the overall maximum number of keys that may be stored in the graph and ω is the maximum number of adjacent bits that may be retrieved in a single vertex. Since there is a limit on the number of bits that may be retrieved any sequence where t−f>ω yields an infinite ∞ composite cost. A bit index that has been retrieved in one or more ancestor vertices is said to be ‘checked’, and such bits are considered for repeated retrieval if it improves the overall sequence. Any sequence including a pair of non-checked bit indices i and j such that n_{i*}, ≠n_{j*} yields composite cost ∞. For any other bit sequence, let n_{*} be the number of wildcard bits in the non-checked bit positions. Any sequence where n_{*}>0 that include one or more checked bits, or where f≠t, yields composite cost ∞. To clarify, for sequences where the keys contain wildcards in the bit positions selected a shorter sequence is preferred over a longer sequence. Furthermore, any sequence where n_{*}=0 that includes a checked bit i such that n_{i*}>0 yields composite cost ∞. Finally, the composite cost is computed as a function of α, β, f, t and the quantum key, where α=2^{Σ}^{_{t=f}}^{γ}^{ᵢ}^{^{t}}, γi=0 if nᵢ₀=0 and nᵢ₁=0, and 1 otherwise, and δ=min(|nᵢ₀−nᵢ₁|, i=f . . . t). Parameters of the cost function are configured to achieve optimal bit selection for the respective target applications.

In an alternative quantum key based multiple bit retrieval embodiment, guaranteed to check each bit only once, the ‘composite cost’, for selecting a ‘sequence’ f . . . t of multiple adjacent bit indices starting with f and ending with t, is computed as follows as described above except that any sequence including a checked bit yields composite cost ∞.

In all quantum key based multiple bit retrieval embodiments the bit sequence with the smallest composite cost is chosen and the set of specified arc labels is computed by retrieval of the bits from the respective keys according to the chosen sequence. Keys are distributed into subsets according to which specified arc label that can be obtained from the respective key and an arc to a subgraph is created for each subset followed by recursively constructing the respective subgraph for each specified arc.

### Search

In general, search refers to the process of starting at a given vertex, which is typically a/the ‘root’ and locating all reachable keys stored in the graph that ‘matches’ a given ‘query key’. By matches we mean that for each specified bit in the query key the corresponding bit in the matching key stored in the graph is either equal or wildcard. For computer networking applications the query key is often fully specified (there are no wildcard bits). However, there are also applications where query keys contain one or more wildcard bits. This is called ‘full multi-match search’.

Graphs where keys are associated with priorities may also support search of the matching key with highest priority, a given number of matching keys with the highest priorities, or all matching keys in order of decreasing priority. Note that this either requires some tie breaker mechanism to be available for matching keys with equal priorities or that priorities are unique.

A weaker form of search is to locate a set of candidate keys, which is a subset of the set of keys stored in the graph, that may match the query key. In this way, the set of candidate keys is reduced in size compared to the original set of keys stored in the graph and the detailed investigation of which of these candidates that are matching the query key can be performed in a second operation using whatever method that is available. This is called ‘partial match search’.

For each vertex visited during search the arc label (if the query key is fully specified) or set of arc labels (if the query key contains wildcards) is retrieved using the bit retrieval method and computed using the arc map computation method specified in the vertex. Search is then performed recursively in each subgraph reachable via the specified arc with a specified arc label equal to any of the arc labels retrieved from the query key. If there are no specified arc labels that matches the arc labels obtained from the query key, search is performed recursively in the unspecified subgraph if such a subgraph is available. Furthermore, search is also performed recursively in the mandatory subgraph if such a subgraph is available. If the vertex visited contains specified data with specified data that matches any of the data labels obtained by computing the data map of the key such matching data is output. If the data labels obtained from the key do not match any specified data label, the unspecified data is output if such data is available in the vertex. In addition, any mandatory data in the vertex is output independently of whether there is a specified data label match or not. If the vertex does not contain any arcs that can be traversed, the search halts.

In one embodiment, suitable for classification of Internet datagrams (or packets), query keys are fully specified, and only specified and unspecified arcs are used (no mandatory arcs). In such an embodiment, a single arc label is obtained from the query key at each node. Such an arc label is either matched against exactly one specified arc label and the search continues in the associated specified subgraph or does not match any of the specified arc labels in which case the search continues in the unspecified subgraph if an arc leading to such a subgraph is available in the vertex. If the arc label from the key does not match any of the specified are labels and no unspecified subgraph is available, the search is terminated after processing any data present in the node as outlined above.

In an alternative embodiment, also suitable classification of Internet datagrams (or packets), query keys are fully specified, and both specified-, unspecified-, and mandatory arcs are used. In such an embodiment, a single arc label is obtained from the query key at each vertex. Such arc labels are either matched against exactly one specified arc label and the search continues in the associated specified subgraph or does not match any of the specified arc labels in which case the search continues in the unspecified subgraph if an arc leading to such a subgraph is present in the vertex. In addition, search is always performed recursively in the mandatory subgraph if such a subgraph is available. If the arc label obtained from the key does not match any of the specified edge values, no unspecified subgraph is available, and no mandatory subgraph is available, the search is terminated after processing any data present in the node as outlined above.

### Updates

Graph construction has been described above from the perspective of construction of graphs from scratch. It has also been mentioned briefly, in the context of single bit retrieval arc and data maps and associated vertex construction, that keys can be inserted on-the fly, while dynamically updating the graph rather than reconstructing it from scratch. This is called an ‘incremental update’ of the graph.

There are two main incremental update operations: ‘insert’ key and ‘delete’ key, both referring to single key operations. Variants of ‘insert’ and ‘delete’ include ‘burst insert’ and ‘burst delete’ for inserting and deleting, respectively, all keys in a set of keys. As a result of an update operation, some part of the graph may need to be maintained or optimized. This is achieved by partial reconstruction, while considering certain metrics recording the state of the graph. Burst updates, insertions as well as deletions, can either be performed as repeated single updates or as a ‘consolidated update’ applied on sets of keys. In both cases, optimization is performed after the burst update is completed. Typically, partial reconstruction does not include partitioning from scratch, as performed during initial partitioning of the keys into subsets and construction of one graph for each subset during a batch build. It may, however, be necessary to move keys between subsets after an update operation. This is achieved in the context of ‘maintenance’ described below.

As mentioned above, partitioning is used to partition the keys into subsets according to some niceness criteria with respect to the other keys in the same subset. The purpose of this is to minimize the amount of replication when constructing the graph for each subset.

The method for ‘insertion’ of a ‘new key’ in a graph is as follows. Insertion of a single key K in an empty subgraph or in a subgraph where an irreducible set of keys is stored (identified by a non-branching root vertex) is achieved by constructing a subgraph as outlined above. Otherwise, in each node encountered, starting with the root vertex, the set of arc values of the new key is computed by using the bit retrieval- and arc map computation method associated with the vertex. For each arc label α present in the set of specified arc labels, of the vertex, insertion is performed recursively in the corresponding α-subgraph. For each β of the remaining arc labels a new β-arc referring an empty subgraph is constructed and the key is recursively inserted in each such empty subgraph. If the embodiment includes mandatory edges, a selection of the remaining arc labels may be skipped by recursively inserting the key in the mandatory subgraph instead.

FIG. 6 shows the graph resulting from inserting the new key *101*011 with data D₅ in the graph shown in FIG. 2. Since bit 5 is wildcard, the new key is replicated in both the 10_{b}and 11_{b} subgraph of the root node. Note also that the new key is replicated in the 10_{b} subgraph since bit 1 is wildcard.

In one embodiment, where partitioning is used to partition the set of keys in subsets and one graph is constructed (and maintained), each subset of keys, and the corresponding graph the keys are stored in, is associated with a quantum key. In such embodiments, the distance between the new key to be inserted and each of the quantum keys is computed and the new key is inserted into the graph associated with the quantum key yielding the shortest distance.

In an alternative embodiment, a ‘replication cost’ for each subset, and corresponding graph, is computed for the new key to be inserted. Replication cost is computed ‘simulating’ an insertion and count how many new vertices and arcs that are required to insert the key in the graph. This is followed by inserting the key into the graph with the lowest replication cost. Note that replication cost computed as described herein is a heuristic since the actual impact of adding a key to an existing graph can only be assessed with certainty by reconstructing the entire graph from scratch.

### Partitioning and Construction for Longest Prefix Matching

The purpose of partitioning is primarily to obtain a partition of keys such that an efficient graph can be constructed for each subset. There are two aspects of efficiency to consider, ‘space’ and ‘time’. ‘Space efficiency’ aims at minimizing the number of vertices and arcs required to represent the graph whereas ‘time efficiency’ aims at minimizing the number of vertices that are visited during search. Time efficiency optimization targets include ‘worst case time efficiency’ considering the maximum number of vertices visited during search for any wildcard free query key or any query key with a limited number of wildcards (a query key where all bits are wildcards matches all keys stored in the graph and the entire graph is thus traversed).

For Longest Prefix Matching (LPM) keys are prefixes. This means that specified bits are located first in the key starting at index 1 if the key is viewed as a bit array (or at the most significant bit of the key is viewed as an unsigned integer) and continues until the first wildcard bit occurs. At that point all following bits are also wildcard. The number of specified bits is called the length of the prefix. Thus, for a key of length w, the available prefix lengths are 0, 1, 2, . . . , w.

As the name suggests, the longest prefix that matches a query key is selected as the winner if there are more than one match. If the number of graphs is at least w+1, a separate graph can be associated with each prefix length and only the prefixes with that prefix length are stored in the graph.

In such a scenario, the data map function in the root node, which is also the only node, in each graph extracts all specified bits from the prefix and assigns to each labelled data the next-hop information to be associated with the prefix. Construction of such root nodes is trivial and only requires that the partitioner distributes prefixes to graphs according to prefix lengths.

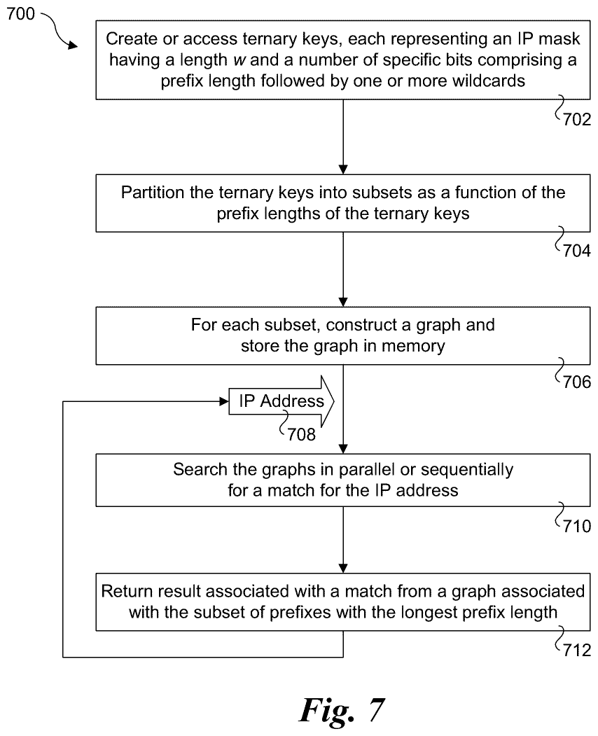

FIG. 7 shows a flowchart 700 illustrating operations for determining a longest prefix match, according to one embodiment. The process begins in a block 702 in which ternary keys are created or (previously created keys are) accessed, with each ternary key representing an IP mask having a length w and a number of specific bits comprising a prefix length followed by one or more wildcards.

In a block 704, the ternary keys are partitioned into subsets as a function of the prefix lengths of the ternary keys. As depicted in a block 706, for each subset a graph is constructed and the constructed graph is stored in memory. In some embodiments the graphs are stored in memory as sub-tables. In some embodiments, the entries in the sub-tables include information or indicia identifying a port for a next-hop along a routing path to a destination IP address.

The remaining operations are performed in a loop-wise manner. As depicted by an arrow 708, an IP address is received as an input. In embodiments in which packets are received, the IP address may be extracted from the packet header using techniques known in the art. For example, the IP address may be a destination IP address to which the packet is to be routed or forwarded.

In a block 710 the graphs are searched in parallel or sequentially for a match for the IP address. This may result in one or more matches. As depicted in a block 712, the result associated with a match from a graph associated with the subset of prefixes with the longest prefix length is returned. In some embodiments, the value returned is the information or indicia identify the port via which the packet will be forwarded to the next hop along the routing path. The logic then loops back to process the next IP address using the operations of blocks 710 and 712.

Partitioning with a Cost Function

In some embodiments, partitioning is performed in a manner that minimizes a cost function. If the number of graphs s is less than w+1, the prefix length space is partitioned into s subsets [w₀, w₁], [w₁+1, w₂], [w₂+1, w₃], . . . , [wₛ₋₁, wₛ], where w₀=0, wₛ=w. Considering the statistical prefix length distribution P, let Pᵢ be the expected (or measured) percentage of prefixes of length i. The cost of a prefix length partition w₁, w₂, . . . , wₛ with respect to distribution P is computed as follows:

$${\sum }_{i = 1}^{s} {\sum }_{j = {w}_{i - 1}}^{{w}_{i}} {P}_{j} {2}^{{w}_{i} - j}$$

Obtaining the optimal prefix length partition for a given number of graphs s and a prefix length distribution P is achieved by using dynamic programming to compute the prefix length partition with minimum cost.

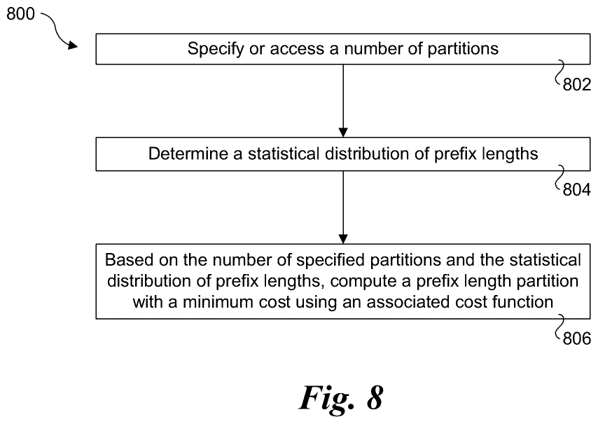

FIG. 8 shows a flowchart 800 illustrating operations for performing a prefix length partition using a cost function, according to one embodiment. In a block 802 the number of partitions is specified. Optionally, if the number of partitions has previously been specified, the number of partitions are accessed, e.g., such as via an input to software or a variable stored in memory or stored in a register or the like.

In a block 804, a statistical determination of prefix lengths is determined. This determination may be performed using known methods or schemes, with the particular method or scheme being outside the scope of this disclosure. In a non-limiting example, a table is created with rows having a prefix length field and a frequency field.

Continuing at a block 806, a prefix length partition with a minimum cost using as associated cost function is calculated based on the number of specified partitions and the statistical distribution of prefix lengths.

An alternative and less strict approach is to use a set of overlapping prefix length intervals rather than a partition. If the overlap is at most one, i.e. that the maximum length in an interval does not exceed the minimum length of the next interval, then the matching graph still defines the priority of the match.

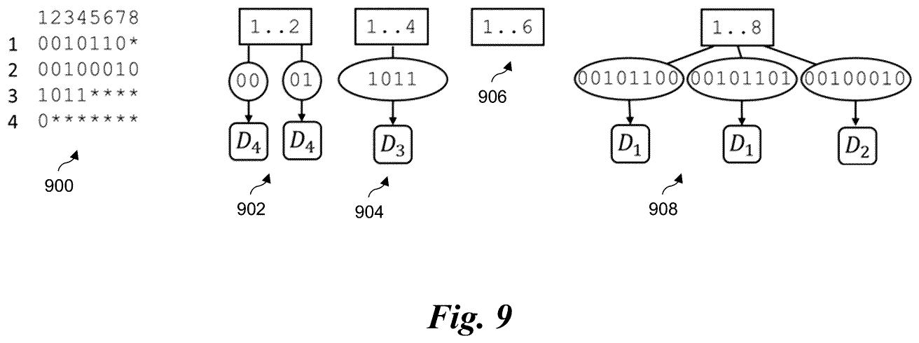

FIG. 9 shows a table 900 of four prefixes and four small graphs 902, 904, 906, and 908 constructed from these prefixes using the prefix length partition [0,2], [3,4], [5,6], [7,8]. Note that graph 906 where bits 1 . . . 6 are selected is empty since there is no prefix of length five or six. Also note that the data associated with the first and fourth prefix are replicated.

In TABLE 1 below we show calculation of the cost for a prefix length partition [0,12], [13,20], [21,24], [25,32] using the number of occurrences (frequency) rather than percentage/probability. The resulting cost then becomes a measure of the number of next-hop entries required in the worst case to represent the table.

TABLE 1

| Frequency | Length | Multiplier | Cost |
|---|---|---|---|
| 0 | 0 | 4096 | 0 |
| 0 | 1 | 2048 | 0 |
| 0 | 2 | 1024 | 0 |
| 0 | 3 | 512 | 0 |
| 0 | 4 | 256 | 0 |
| 0 | 5 | 128 | 0 |
| 0 | 6 | 64 | 0 |
| 0 | 7 | 32 | 0 |
| 17 | 8 | 16 | 272 |
| 13 | 9 | 8 | 104 |
| 39 | 10 | 4 | 156 |
| 103 | 11 | 2 | 206 |
| 300 | 12 | 1 | 300 |
| 581 | 13 | 128 | 74368 |
| 1216 | 14 | 64 | 77824 |
| 2125 | 15 | 32 | 68000 |
| 13663 | 16 | 16 | 218608 |
| 8561 | 17 | 8 | 68488 |
| 14364 | 18 | 4 | 57456 |
| 26297 | 19 | 2 | 52594 |
| 45763 | 20 | 1 | 45763 |
| 54522 | 21 | 8 | 436176 |
| 113765 | 22 | 4 | 455060 |
| 106101 | 23 | 2 | 212202 |
| 574936 | 24 | 1 | 574936 |
| 483 | 25 | 128 | 61824 |
| 617 | 26 | 64 | 39488 |
| 1005 | 27 | 32 | 32160 |
| 73 | 28 | 16 | 1168 |
| 112 | 29 | 8 | 896 |
| 27 | 30 | 4 | 108 |
| 30 | 31 | 2 | 60 |
| 479 | 32 | 1 | 479 |
| 965192 | | 8716 | 2.48E+06 |
| | | | 2478696 |

In some embodiments, the graphs comprise single node space graphs, wherein searching a single node space graph only requires processing a single graph node. Let's say that one subset contains prefixes of length 4-8. Prefixes of length 4 has the 4 most significant bits specified and all other bits wildcard whereas prefixes of length 8 has the 8 most significant bits specified and the rest wildcard. Without loss of generality, let's assume that these are IPv4 prefixes so the maximum length is 32-bit. A single node graph for this basically uses direct indexing on the 8 most significant bits and effectively works as an 8-bit M-trie node (except that we don't need to pay for empty slots since it is stored in associative memory, in one embodiment). A prefix of length 8 is stored in exactly one child of the node and a prefix of length 4 is stored in up to 2\hat{ }4=16 children of the node. However, if we have A=0b1010****** . . . * and B=0b10100000** . . . *, B is the longer prefix of child 0b10100000 and A does not need to be stored there. Hence, for each child there will be a single prefix and that is (by how the maintenance algorithm operates) the longest prefix of that child. When an update is performed, it only needs to check the applicable children and if the new inserted prefix is longer than a child it simply replaces the child. This gives super-fast updates as well.

To simplify the description, partitioning and construction have been described in the context of one-time initial partitioning of a set of keys and batch construction of graphs, respectively. However, in some embodiments, keys are inserted on the fly, with both the partition and the subgraphs being updated and maintained on-the-fly to achieve efficient operation. Therefore, whenever the operations partitioning and construction are mentioned herein, they mean both initial batch partitioning and construction as well as on-the-fly maintenance, including complete and/or partial repartitioning and reconstruction, of partition and subgraphs.

### Graph Memory Engine

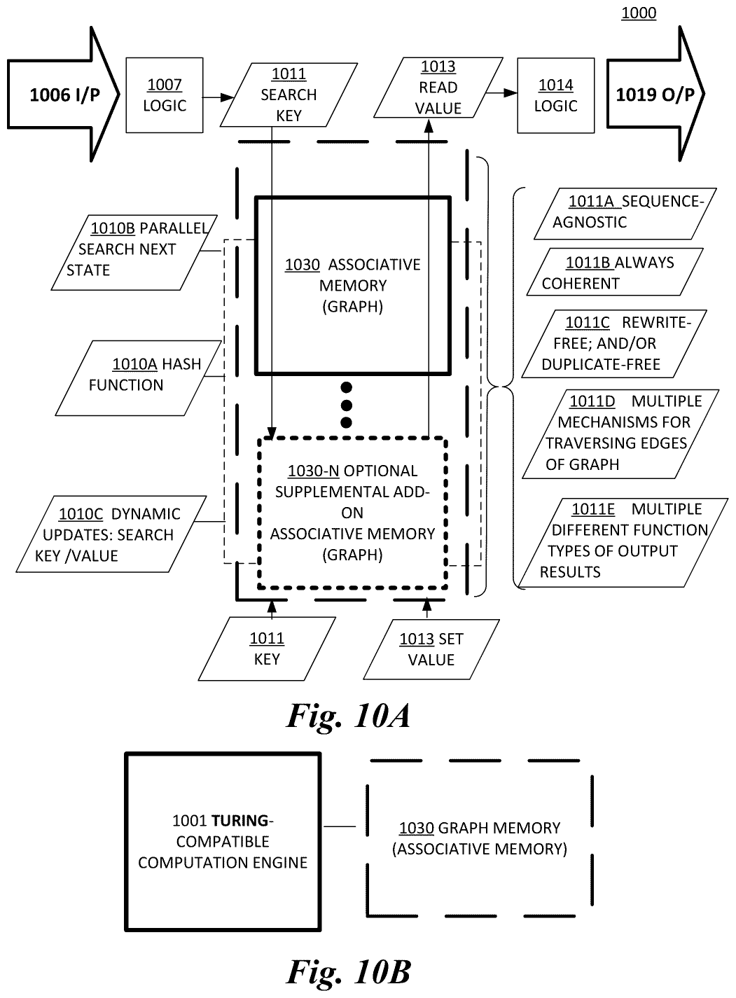

In some embodiments a graph memory engine and associated memory are used. Referring now to FIG. 10A, a functional block diagram is shown of a graph memory engine 1000. The present embodiment advantageously utilizes an associative array for a graph function, which results in faster lookups than a list solution, and denser, higher efficiency memory space usage than an index solution. Specifically, since the desired node is identified directly and discretely in the present embodiment of associated memory, it is typically much faster than a sequential evaluation of each entry in a list until the desired entry is found for the list solution. Conversely, the present associative memory for a graph function results in smaller memory sizes, or much higher efficiency than an indexing solution in memory, since the desired node is identified directly and discretely in the present embodiment, rather than a sequentially addressed memory space, which results in inefficient memory use, especially for a sparse matrix with very few entries. Subsequent figures with specific examples will clearly illustrate these numerous improvements of the present embodiment over the alternative solutions.

Associative memory 1030 can be implemented in either a random access memory (RAM), a ternary content addressable memory (CAM), a field programmable gate array (FPGA), or etc., depending on the speed, size, and power requirements of a given application, as known by those skilled in the art.

In one embodiment, a hash operation 101A, known to those skilled in the art, is used to load in specific memory locations, a graph whose shape and function is defined by the quantity and identification of one or more nodes with their respective associated data (together, key 1011). This associated data includes node values, one or more edges (if any), associated tests or functions (if any), etc. (together, set value 1013).

Processing input data 1006 according to the graph disposed in associative memory 1030 starts with logic block 1007 (e.g., hashing) to generate a search key to find the appropriate node and its associated data for the given input value. Hashing is a fast, low power, and spatially efficient method of locating a key disposed in memory. A parallel search function 1010B of a search key locates the key in one or more associate memories 1030, 1030-N, where N is any whole number integer. That is, regardless of the quantity of original or supplemental add-on associative memory, the hash function, once set up and managed, can search the entire range of original or supplemental add-on associative memory.

Another benefit of associative memory is the ability to implement a dynamic update function 1010C of stored key, including node ID, edge data, and associated data such as functions, operations, actions (test algorithm, mathematical relationships, type of data tested, etc.). In other words, a specific discrete key and associated data can be written to associative memory 1030 dynamically, (when appropriate memory location is not accessed), with a corresponding update in a hash table if necessary. Edges of graph (instructions) can be added incrementally without having to rewrite memory or require duplicate copies of subgraph. The edge is easily written into memory where the hash function would place its specific position given the edge value from the hash and the node ID to which it belongs. Alternatively, another embodiment can lock down the population of a given graph in associative memory to prevent updates if that is desired for a given application.

A specific example is provided in a subsequent figure, as driven by a host processor. Note that graphs implemented in memory using list and index functions are typically static and are difficult to update on the fly. If they are updated at all, it requires multiple cycles during which access is ‘locked out’, during the updates in order to maintain coherency.

An associative memory that uses hashing creates very compact memory utilization, especially for a sparse matrix. It is much more efficient and dense than the alternative technology of using a list for managing a graph. This is primarily because memory usage must grow exponentially with the width, N, of the key (2N memory size) for an index solution using lookup tables (LUTs). In contrast, the associative memory of the present embodiment is typically very compact, and approximately linear, but certainly not remotely near an exponential growth.

Other beneficial features of storing a graph in associative memory and traversing the graph by hashing input for a search key include: (i) sequence-agnostic function 1011A of associative memory; (ii) always coherent memory function 1011B; (iii) rewrite-free and duplicate-free functions 1011C; (iv) multiple mechanisms function 1011D for traversing edges of graph; and (v) multiple different function types of output results 1011E.

Specifically, for (i), sequence-agnostic function 1011A for associative memory allows hashed keys to be consistently located where the hash associates the key, regardless of the sparsity of the matrix, and regardless of normal sequence such as that used in an index function graph. Ensuring an efficient and non-aliased (or rarely aliased) hash improves the existing embodiment even more.

Additionally, for (ii) always-coherent memory 1011B results because of the hash functionality, as applied to a memory graph, which allows discrete write accesses. Thus, the present embodiment does not require re-sorting of an alternative solution that is a list function where a list is resequenced for a newly added entry to the list, e.g., in a middle of the list. Alternative solutions of list and index functions tend to have other memory management issues involved with coherency, such as memory allocation, garbage collection, heap management, etc. A list function implementation that uses high fan-out (many edges leaving a graph node) with a large key can also cause an undesirable increase in processing time.

Returning to the top of FIG. 10A, the set value 1013 is read, and then operations in logic block 1014 are performed to generate an output 1019. Non-limiting examples of output 1019 include information to find the next node to continue the search, some simple action data, or an index to a table with more complex data.

With the present solution, the hash function manages these coherency and other memory management issues without the overhead associated with the noted alternatives, thereby resulting in a less computationally intensive operation, with a comparable less frequent debug occurrence.

Those functions suffered from memory management challenges such as memory allocation, garbage collection, and heap management,

Furthermore, the present embodiment is also (iii) rewrite-free function and a duplicate-free function 1011C meaning that edges of a graph (instructions) can be added incrementally without having to rewrite memory or require duplicate copies of subgraphs (coherency and handoff issues). Instead, the present embodiment simply adds a new edge discretely in memory where the hash function would place it, assuming no aliasing.

One additional benefit of the present embodiment is (iv) multiple mechanisms for traversing edges of a graph, including edge-selection based on a certain value (the sole mechanism for index and list functions) based on a test, based on a mathematical relationship or algorithm, etc.

Finally, item (v) multiple different types of output results are provided by the present invention besides just geographical endpoint information. This result can be thought of as a pointer, e.g., to an address containing data. Instead, the present embodiment can provide geographic endpoint information as well as numeric values, queues, sorting and sequential placement functions, etc.

More examples to these benefits and advantages are provided by way of example in the subsequent figures with specific graphs, memory entries, different functional outputs, etc. Overall, the present embodiment results in a fast execution, with efficient and dense memory utilization, along with desirable features such as being memory sequence agnostic, being amenable to dynamic memory updates, and having always coherent memory.

Referring now to FIG. 10B, a functional block diagram of a Turing-compatible computation engine 1001 sourcing instructions from a graph memory 1130, according to one or more embodiments. A Turing-compatible computation engine 1001 includes storage, conditional branching, instructions, and an input and output. In addition, the Turing completeness of a system is said to be the ability for a system of instructions to simulate a Turing machine theoretically capable of expressing all tasks accomplishable by computers. In the present embodiment, a canonical requirement of a Turing machine that is not required is a sequential memory to store data. Yet, a non-sequential memory for storing data, or program instructions, that is accessible for state changes, satisfies a functional requirement of operation. For more details, see reference John Hoperoft and Jeffrey Ullman (1979). Introduction to Automata Theory, Languages, and Computation (1st ed.). Addison-Wesley, Reading Mass. ISBN 0-201-02988-X. Centered around the issues of machine-interpretation of “languages”, NP-completeness, etc.

While in concept a machine which is Turing complete is not required to execute instructions sequentially, most all execution engines have a “program counter” implying that the norm is to execute instructions in sequential memory location, where branching is the exception to the norm. This allows CPU instruction caches with prefetch to work because a burst load from main memory to load the cache assumes that some number of locations after the missed address location will be needed for execution before the next branch happens. This is testimony to the fact that programs and CPUs execute instructions in a sequence before branching. This tends to set the burst size of DRAMs, which has been optimized for cache line refills to support the average instruction execution run lengths before branching.

What sets the present embodiment apart from conventional architectures is that present embodiments are Turing complete and assume that every new instruction executed can come from a non-sequential address. This facilitates applications that are patterned after decision trees and graph processing.

### Gme System Architecture

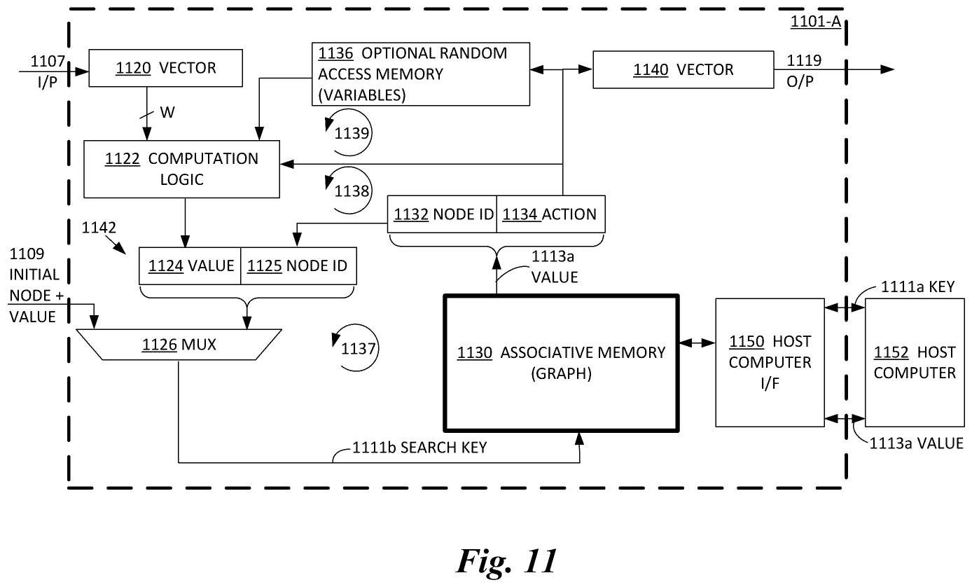

Referring now to FIG. 11, a schematic block diagram of a graph memory engine (GME) 1101-A is shown, according to one or more embodiments. Present FIG. 11 is one embodiment of Turing-compatible computation engine 1001 of FIG. 10B, and particularly that a next program instruction is fetched from memory, e.g., in this case via a computed value. GME 1101 provides a component level schematic of the data flow and control in GME 1101-A used to generate a new search key, and a resultant value output from associative memory that advances a state in the automata scheme along the graph memory. In one embodiment, GME 1101-A performs a similar function to a CPU or GPU, and thus, with some system adaptations, is a socket alternative. The present disclosure envisions a wide variety of internal coupling arrangements and feedback loop arrangements with different or additional functional blocks disposed therein, in different embodiments to accomplish different data processing applications more efficiently in terms of one or more resources.

GME 1101-A comprises, at its core, an associative memory 1130, an embodiment of graph memory 1030 of FIG. 10B, which stores therein graph data in the form of one or more nodes (or vertices), its respective (zero to many) edge values (or vectors) pointing out from each of the nodes, and the associated downstream node identification (from zero to multiple) and its related operations (if any) associated with each node, such as a next node ID, a result, and an input test. The description of associative memory 1130 (or associative array), provided in FIGS. 10A and 10B applies here.

A true CAM implementation of associative memory 1130 requires neither an index nor a program pointer as inputs from a graph memory engine and requires neither an index nor a program pointer for its internal implementation level. Some associative memory implementations can utilize pointers or indexes on an internal implementation level, but for a current embodiment of the present disclosure, no explicit program pointer or index information is required to be externally input to the associative memory. Rather, the associative memory locates associated data in the memory based on a starting operation of providing an input search key, as known by those skilled in the art to find if any matches exist as a key (same content as search key) already stored in the associative memory. That is, associative memory always starts with a search key value, which is a portion of the content stored in the memory and uses that search key value to locate the memory word line. Other data disposed in the same word line as a key, is relevant associated data that is output as a desired information and tied to the search key first used.

One embodiment uses a TCAM memory for some of the prefix subsets (preferably the shorter lengths where the number of possible unique prefixes is heavily limited by the prefix length), and associative memory/GME/sparse/dense representation for other subsets yielding a hybrid approach.

A hash table implementation of associative memory 1130, calculates possible locations of a search key in the memory, with an output including a small finite number of several locations or less that could be the desired memory location. Each of those results from the small finite number of several locations are discretely retrieved and checked to verify a matching key to the search key.

A search key 1111b is generated from a pipeline of components coupled to each other beginning with a memory register vector 1120 coupled to computation logic in parallel with an input from optional RAM 1136 (for storing variables). The search key is a state identifier, which is a node ID of a memory graph in the present embodiment that is adjoined, or concatenated, with an edge value in search key generator 1142. The edge value is an output of at least a portion of an input vector and/or a variable (or arbitrary value) from RAM 1136. Computation logic 1122 couples downstream to memory register value 1124 and memory register node ID 1125 whose combined output is multiplexed by mux 1126 with an initial node and value input 1109. Output from mux 1126 feeds into associative memory 1130 as a hashed value to determine a value output 1113a comprised of a next instruction, stored as memory register next node ID 1132 and memory register next action 1134. Mux 1126 is simply an element to allow for initialization or starting point the graph memory operation.

An input data string 1107 is stored as a vector in a register or cache memory 1120. A portion or all of the vector is selected (bit width ‘W’) (per an action from associative memory 1130) and communicated to coupled computation logic 1122, which said logic is designed for performing given tests, operations, etc. from memory register action 1134 fed thereto, along with optional variable(s) from RAM 1136, all coupled together. Computation logic 1122 optionally includes an arithmetic logic unit (ALU) module therein for performing mathematical operations and/or tests on input vector. Examples include a ternary match, test one or more bits against some value, mathematical logic such as equalities or inequalities greater than or less than, multiply operation, Bayesian calculation, support vector machines (SVM) (sorting and sequencing), extract bits, determine a range of bits, etc.

In the present embodiment, output value 1113a from associative memory 1130 is not a pointer value per se, e.g., not a program pointer for instructions, as used in prior art solutions, such as index-based graph memory. Rather, output value 1113a is an instruction comprised of a node ID 1132 and an action 1134 (stored in a register, cache, etc.) used to generate a new search key 1111b. The action can be a wide range of functions, tests of input or RAM, operations to generate output results to a queue and/or output data results, as described in examples of subsequent figures. Specifically, Node ID 1132 is a current node ID that is fed back into a node ID 1125 portion (stored in a register, cache, etc.) via recursive loop 1137 for a new search key 1111b that is output from mux 1126. Ultimately, output value 1113a from associative memory 1130 directly and indirectly is used to form a new unique search key 1111b that will then match one entry in associate memory to yield a next output value from a hashed memory location. Thus, again, associative memory 1130 does not store or output pointers per se, to an indexed memory location in associate memory. Rather, a complex algorithm and relationship working on the output instruction 1113a from associative memory along with input data string 1107, optional random access memory (RAM) variables 1136, and other action and computational logic operations 1122 result in the new search key 1111b.

The hardware components in FIG. 11 are coupled to form recursive loops 1137, 1138, and 1139 to feedback data output from associative memory 1130 to create a new search key for advancing a state in the automata scheme, by traversing the associative array. These feedback loops manifest as graph memory progression along a given branch, or edge, from a given node to a next node in the graph memory. Said automata scheme will be clearer in examples illustrated in subsequent figures. Also feeding this new search key 1111b is an output from memory register for action 1134 that inputs an action into computation logic 1122 for execution, via recursive loop 1138. Lastly, feeding into the new search key 1111b is the output from memory register for action 1134 that parallelly feeds into optional RAM 1136 for selection of an optional variable to be fed into combination logic 1122, all via recursive loop 1139. The recursive hardware and respective data feedback loops 1137-1139 enable the associated node, tests, and action output from associative memory 1130 to advance the automata graph memory engine to a next node and edge defined by the search key it generates.

Output 1119 from GME 1101-A can be a wide range of values ranging from a numerical value, a geographical position, etc. Output 1119 is processed in memory register vector 1140 from memory register action 1134 as derived from value 1113a output from associative memory 1130.

A GME system 1101-A is formed when GME 1101-A is communicatively coupled via a host computer interface 1150 to host computer 1152 to communicate keys 1111a and values 1113a to program in associative memory 1130. The benefit of using associative memory 1130 for graph memory is that many operating systems utilize languages having associative memory constructs, including but not limited to: C# which has a math function; Python which utilizes a dictionary method; Java etc., used to manage the data graph (e.g., creating, pruning, balancing, etc.). Thus GME 1101-A is software agnostic. Fortunately, the software does not need to control and manage the memory directly in terms of reading and writing accesses, managing resource usage and buffers, and allocating memory, etc. Rather, the associative memory constructs operate independently and transparently, with the hashing function and search key execution being self-managing.

The interface from host computer 1152 to associative memory 1130 allows the dynamic programming of GME 1101-A to update keys 1111a and values 1113a on the fly, in the present embodiment. Because memory is configured as associative memory 1130, it allows an individual access to overwrite a value portion of data associated with a given key disposed therein. New nodes can also be written into associative memory 1130 that did not exist before. The hash operation on a given node and edge determines its location in memory. During a non-operation cycle, or by use of a dual port memory structure, the new node and edge (and associated data of new node, test and/or action) can be written into the appropriate memory location while associative memory 1130 is performing an access to a different memory location. In another embodiment, key and value data is loaded into associative memory 1130 during initialization and left unchanged during an operational period as a static implement (that is not updated or dynamically changed until a new reboot or initialization).

In one embodiment, the use of an associative memory (in any of multiple implementations), that is pointerless and indexless to the GME 1101-A, for fetching a next program instruction and/or deciding whether it is possible to advance to a next state, offers transparent and efficient operation of the GME 1101-A for classification, filtering, and other functions. For example, using an associative memory in the present embodiment, GME 1101-A, an edge value width of 2F bits is possible, where F is a whole positive integer, which means a fan-out capability of 2F entries in a single level with efficient memory usage. This is possible without GME 1101-A using a program pointer and index management system of memory that would require 2F entries.

For example, if the present embodiment had only two edge values in the 2F space (a sparse matrix), then the associative memory 1130-A would have only two entries in memory space. In comparison, an indexed RAM managed memory by an alternative graph solution, would require the full 2F memory space be allocated for only two edge value entries in a single level (shallow tree). An alternative indexed memory managed approach would be to create a high or wide (a tall tree) with multiple levels, say only two edges for each level, then it would require F levels, which adds lookup time, energy consumption, and other memory management headaches such as location tracking, coherency, garbage collection, heap management, more extensive locations updates, etc. Granted, associative memory is more expensive than non-associative RAM memory. But the net overall gain of using associative memory for GME 1101-A for traversing program instructions, especially for high utilization of branching and/or high-utilization of fan-out, in memory and advancing states, is clearly superior with associative memory, for at least the reasons of (i) memory is efficiently utilized and wasted space for sparse matrices is minimal; and (ii) the result is a transparent program instruction memory storage and access that is fast, efficient, and low overhead. Specifically, the multiple available implementations of the associative memory is disassociated with the use thereof by GME 1101-A. Applications that use these feature strengths are classification applications and algorithms such as graph processing, and more specifically, classification systems such as packet classification, network traffic management, as well as machine learning classification applications.

Overall, GME 1101-A provides a fast, low power, area efficient, compact, self-contained, and programmable graph database that is dynamically updatable, provides reliable coherency every cycle, and has numerous customizable operations, tests, and outputs that are not available on any other solution. While GME 1101-A is illustrated as a hardware schematic, the functionality and sequencing of the components and operations can be implemented in a wide range of combinations of hardware, firmware, software solution as well. Therefore, for example, illustrated components can all being integrated on a single chip, on a single or multi-chip module package, as discrete components on a board or a card, etc. Alternatively, some block components could be implemented as firmware, with others implemented as hardware. Any combination of register transfer logic (RTL), firmware, proprietary or hardware memory engine, general-purpose processor, FPGA, GPU, and other processing units can be combined to provide the means for the functional blocks shown. Associative memory 1130 is typically off-chip, but can be on-chip, or a combination thereof.

In some embodiments, an implementation may use associative memory without some of the other components and logic used by a GME. Instead of using a single root node for graph memory, any mechanism capable of associating a nonnegative integer with a width of w bits—where w represents the longest prefix length in the graph—with corresponding next-hop details (or NULL if the prefix doesn't exist) is suitable. Known mechanisms include M-trie nodes, sparse set representations, lists, compressed dense M-trie nodes with Lulea-style bitmaps, and sparse nodes. The choice of mechanism should be based on the number of next-hops and the desired balance between processing speed and memory usage.

### Example Implementation Environments

Generally, the algorithms and methods described and illustrated above may be implemented in software, programmable hardware, or a combination of the two. For example, in some embodiments the algorithms may be implemented via software instructions (code) that is executed on a processor, central processing unit (CPU) or the like. The processor/CPU may be a multi-core processor with multiple processor cores. The workload may be portioned into multiple threads or the like that may be executed on one or more of the processor cores. Apparatus that may be used for executing such software include but are not limited to computing devices, such as servers, appliances, infrastructure processing units (IPUs), data processing units (DPUs), Edge Processing Units (EPUs), network forwarding elements (e.g., network switch/router), and others.

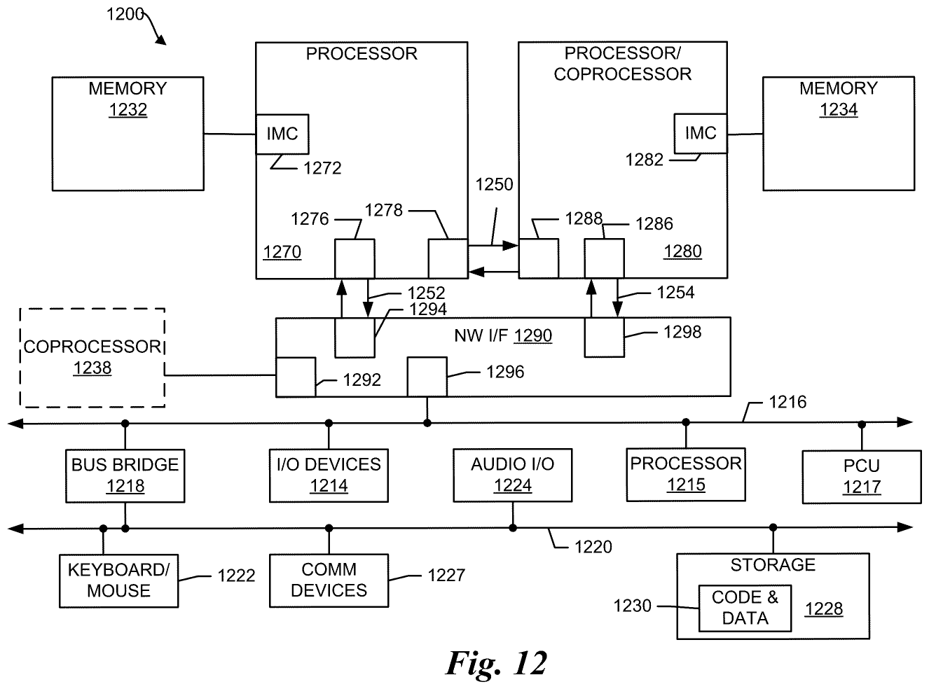

FIG. 12 illustrates an example computing system. System 1200 is an interfaced system and includes a plurality of processors or cores including a first processor 1270 and a second processor 1280 coupled via an interface 1250 such as a point-to-point (P-P) interconnect, a fabric, and/or bus. In some examples, the first processor 1270 and the second processor 1280 are homogeneous. In some examples, first processor 1270 and the second processor 1280 are heterogenous. Though the example system 1200 is shown to have two processors, the system may have three or more processors, or may be a single processor system. In some examples, the computing system is a system on a chip (SoC).

Processors 1270 and 1280 are shown including integrated memory controller (IMC) circuitry 1272 and 1282, respectively. Processor 1270 also includes interface circuits 1276 and 1278; similarly, second processor 1280 includes interface circuits 1286 and 1288. Processors 1270, 1280 may exchange information via the interface 1250 using interface circuits 1278, 1288. IMCs 1272 and 1282 couple the processors 1270, 1280 to respective memories, namely a memory 1232 and a memory 1234, which may be portions of main memory locally attached to the respective processors.

Processors 1270, 1280 may exchange information with a network interface (NW I/F) 1290 via individual interfaces 1252, 1254 using interface circuits 1276, 1294, 1286, 1298. The network interface 1290 (e.g., one or more of an interconnect, bus, and/or fabric, and in some examples is a chipset) may optionally exchange information with a coprocessor 1238 via an interface circuit 1292. In some examples, the coprocessor 1238 is a special-purpose processor, such as, for example, a high-throughput processor, a network or communication processor, compression engine, graphics processor, general purpose graphics processing unit (GPGPU), neural-network processing unit (NPU), embedded processor, or the like.

Generally, in addition to processors and CPUs, the teaching and principles disclosed herein may be applied to Other Processing Units (collectively termed XPUs) including one or more of Graphic Processor Units (GPUs) or General Purpose GPUs (GP-GPUs), Tensor Processing Units (TPUs), Data Processing Units (DPUs), Infrastructure Processing Units (IPUs), Edge Processing Units (EPU), Artificial Intelligence (AI) processors or AI inference units and/or other accelerators, FPGAs and/or other programmable logic (used for compute purposes), etc. While some of the diagrams herein show the use of CPUs and/or processors, this is merely exemplary and non-limiting. Generally, any type of XPU may be used in place of a CPU or processor in the illustrated embodiments. Moreover, as used in the following claims, the term “processor” is used to generically cover CPUs and various forms of XPUs.

A shared cache (not shown) may be included in either processor 1270, 1280 or outside of both processors, yet connected with the processors via an interface such as P-P interconnect, such that either or both processors' local cache information may be stored in the shared cache if a processor is placed into a low power mode.

Network interface 1290 may be coupled to a first interface 1216 via interface circuit 1296. In some examples, first interface 1216 may be an interface such as a Peripheral Component Interconnect (PCI) interconnect, a PCI Express interconnect or another I/O interconnect, such as but not limited to COMPUTE EXPRESS LINK™ (CXL). In some examples, first interface 1216 is coupled to a power control unit (PCU) 1217, which may include circuitry, software, and/or firmware to perform power management operations with regard to the processors 1270, 1280 and/or coprocessor 1238. PCU 1217 provides control information to a voltage regulator (not shown) to cause the voltage regulator to generate the appropriate regulated voltage. PCU 1217 also provides control information to control the operating voltage generated. In various examples, PCU 1217 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1217 is illustrated as being present as logic separate from the processor 1270 and/or processor 1280. In other cases, PCU 1217 may execute on a given one or more of cores (not shown) of processor 1270 or 1280. In some cases, PCU 1217 may be implemented as a microcontroller (dedicated or general-purpose) or other control logic configured to execute its own dedicated power management code, sometimes referred to as P-code. In yet other examples, power management operations to be performed by PCU 1217 may be implemented externally to a processor, such as by way of a separate power management integrated circuit (PMIC) or another component external to the processor. In yet other examples, power management operations to be performed by PCU 1217 may be implemented within BIOS or other system software.

Various I/O devices 1214 may be coupled to first interface 1216, along with a bus bridge 1218 which couples first interface 1216 to a second interface 1220. In some examples, one or more additional processor(s) 1215, such as coprocessors, high throughput many integrated core (MIC) processors, GPGPUs, accelerators (such as graphics accelerators, digital signal processing (DSP) units, and cryptographic accelerator units), FPGAs, XPUs, or any other processor, are coupled to first interface 1216. In some examples, second interface 1220 may be a low pin count (LPC) interface. Various devices may be coupled to second interface 1220 including, for example, a keyboard and/or mouse 1222, communication devices 1227 and storage circuitry 1228. Storage circuitry 1228 may be one or more non-transitory machine-readable storage media, such as a disk drive, Flash drive, SSD, or other mass storage device which may include instructions/code and data 1230. Further, an audio I/O 1224 may be coupled to second interface 1220. Note that other architectures than the point-to-point architecture described above are possible. For example, instead of the point-to-point architecture, a system such as system 1200 may implement a multi-drop interface or other such architecture.

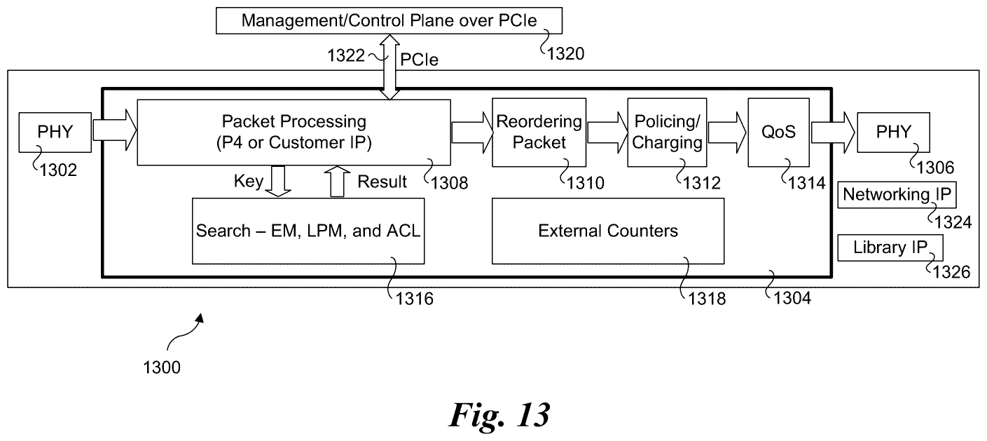

FIG. 13 shows an architecture of packet forwarding apparatus 1300, according to one embodiment. Apparatus 1300 includes a PHY 1302, a main processing block 1304, and a PHY 1306. PHYs 1302 and 1306 are Physical Layer interfaces that are also representative of ports. As will be recognized by those skilled in the art, an input port will include circuitry for converting analog signals used for network communication into digital signals while an output port will internally receive digital signals and convert them to analog signals used for network communication. PHYs 1302 and 1306 may also be called PHY blocks that may further include MAC (Media Access Channel) logic, as is known in the art.

Main processing block 1304 includes a pipeline comprising a packet processing block 1308, a reordering packet block 1310, a policing/charging block 1312, and a Quality of Service (QoS) block 1314. In some embodiments, packet processing block 1308 may comprise a P4 processor or customer Intellectual Property (IP) block. P4 (Programming Protocol-independent Packet Processors) is an open source, domain-specific programming language for network devices, specifying how data plane devices (switches, routers, NICs, filters, etc.) process packets.

Main processing block 1304 further includes a search block 1316 and external counters 1318. Search block 1316 is configured to receive a key from packet processing block 1308 and return a result back to packet processing block 1308. In some embodiments the key is an IP4 or IP6 address, and the result comprises an ACL value or indicia in a LUT entry that matches the key. Under embodiments herein, the matches employ LPM. Search block 1316 may also perform Exact Match (EM). In some embodiments, search block 1316 employs a GME.

Apparatus 1300 also includes network IP 1324 and library IP 1326. These IP blocks may comprise logic, instructions (e.g., software, or FPGA bitstreams), etc., that are accessed by components in main processing block 1304. A management/control plane 1320 also may be used to provide management and control plane inputs to packet processing block 1308 over a PCIe interface 1322.

Generally, main block 1304 may be implemented using blocks integrated on an SoC, or may comprise discrete components. The functionality depicted for main block 1304 may also be implemented using one or more of an FPGA, ASIC, other programmable logic. Main block 1304 may also comprise an IPU, a DPU, or an EPU. Search block 1316 may employ memory, such as associative memory that may be on-chip (e.g., integrated in an FPGA, IPU, DPU, or EPU chip) or in one or more external memory devices.

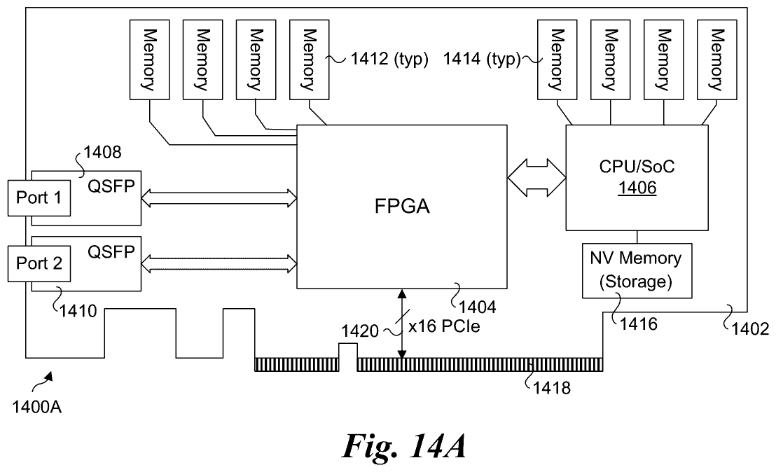

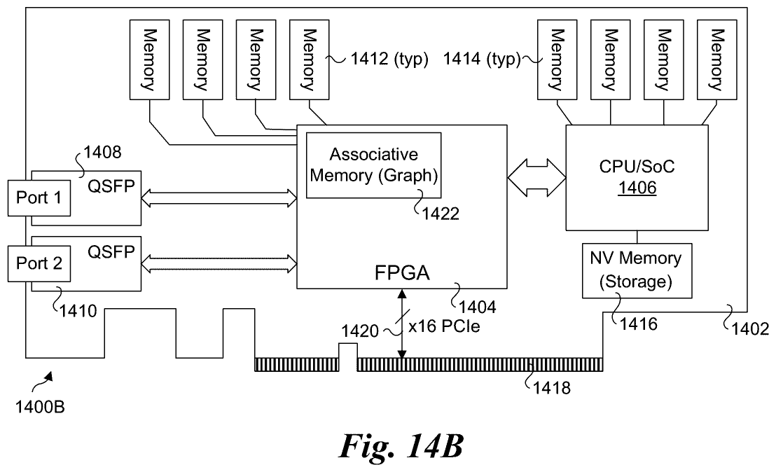

FIG. 14A shows one embodiment of IPU 1400A comprising a PCIe card including a circuit board 1402 having a PCIe edge connector to which various integrated circuit (IC) chips and modules are mounted. The IC chips and modules include an FPGA 1404, a CPU/SOC 1406, a pair of QSFP (Quad Small Form factor Pluggable) modules 1408 and 1410, memory (e.g., DDR4 or DDR5 DRAM chips) 1412 and 1414, and non-volatile memory 1416 used for local persistent storage. FPGA 1404 includes a PCIe interface (not shown) connected to a PCIe edge connector 1418 via a PCIe interconnect 1420 which in this example is 16 lanes. The various functions and logic in the embodiments described and illustrated herein may be implemented by programmed logic in FPGA 1404 and/or execution of software on CPU/SOC 1406. FPGA 1404 may include logic that is pre-programmed (e.g., by a manufacturing) and/or logic that is programmed in the field (e.g., using FPGA bitstreams and the like). For example, logic in FPGA 1404 may be programmed by a host CPU for a platform in which IPU 1400A is installed. IPU 1400A may also include other interfaces (not shown) that may be used to program logic in FPGA 1404. In place of QSFP modules 1408, wired network modules may be provided, such as wired Ethernet modules (not shown).

CPU/SOC 1406 employs an SoC including multiple processor cores. Various CPU/processor architectures may be used, including but not limited to x86, ARM®, and RISC architectures. In one non-limiting example, CPU/SOC 1406 comprises an Intel® Xeon®-D processor. Software executed on the processor cores may be loaded into memory 1414, either from a storage device (not shown), for a host, or received over a network coupled to QSFP module 1408 or QSFP module 1410.

FIG. 14B shows an IPU 1400B comprising an augmented version of IPU 1400A in which FPGA 1404 includes embedded associative memory 1422. Generally, the latency aspect for embedded associate memory will be faster than if the associative memory is implemented in a memory device external to the FPGA. As shown, embedded associative memory 1422 may be used to store graphs and associated data described herein.

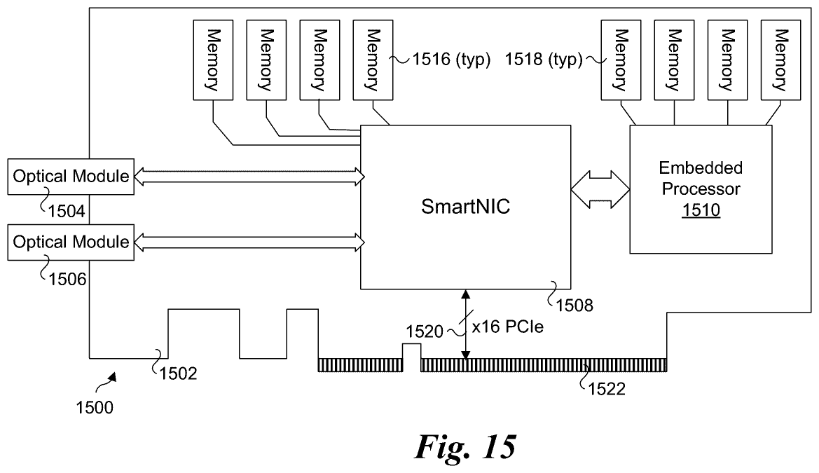

FIG. 15 shows a SmartNIC 1500 comprising a PCIe card including a circuit board 1502 having a PCIe edge connector and to which various integrated circuit (IC) chips and components are mounted, including optical modules 1504 and 1506. The IC chips include an SmartNIC chip 1508, an embedded processor 1510 and memory chips 1516 and 1518. SmartNIC chip 1508 is a multi-port Ethernet NIC that is configured to perform various Ethernet NIC functions, as is known in the art. In some embodiments, SmartNIC chip 1508 is an FPGA and/or includes FPGA circuitry. SmartNIC 1500 further includes a PCIe interconnect 1520 coupled to a PCIe edge connector 1522.

Generally, SmartNIC chip 1508 may include embedded logic for performing various packet processing operations, such as but not limited to packet classification, flow control, RDMA (Remote Direct Memory Access) operations, an Access Gateway Function (AGF), Virtual Network Functions (VNFs), a User Plane Function (UPF), and other functions. In addition-various functionality may be implemented by programming SmartNIC chip 1508, via pre-programmed logic in SmartNIC chip 1508, via execution of firmware/software on embedded processor 1510, or a combination of the foregoing. The various algorithms and logic in the embodiments described and illustrated herein may be implemented by programmed logic in SmartNIC chip 1508 or and/or execution of software on embedded processor 1510.

Generally, an IPU and a DPU are similar, whereas the term IPU is used by some vendors and DPU is used by others. As with IPU/DPU cards, the various functions and logic in the embodiments described and illustrated herein may be implemented by programmed logic in an FPGA on the SmartNIC and/or execution of software on CPU or processor on the SmartNIC. In addition to the blocks shown, an IPU or SmartNIC may have additional circuitry, such as one or more embedded ASICs that are preprogrammed to perform one or more functions related to packet processing and Tx descriptor processing operations.

An EPU may also have similar compute and memory resources as an IPU or DPU where, as its name implements, an EPU is generally implemented at an edge of a distributed environment, such as a cloud edge, data center edge, etc. IPUs, DPUs, and EPUs may be implemented using various configurations, such as an expansion card in a server, a card in a network appliance (e.g., edge appliance), or similar processing and memory resources may be implemented on a system board.

Recently, tile-based SoC and System on Package (SoP) architectures have been introduced. Under such architectures, functionality that might be implemented via an expansion card or the like is implemented in a “tile” of “die” that is part of the SoC or SoP. In some embodiments the SoC/SoP includes an on-package Accelerator Complex (AC) that employs a combination of a new IP (Intellectual Property) interface tile die and disaggregated IP tiles, which may be integrated on an IP interface tile or may comprise separate dies. In one embodiment, the interface tile connects to the System on Chip (SoC) compute CPU tile using the same Die-to-Die (D2D) interfaces and protocol as an existing CPU IO die. This enables high bandwidth connections into the CPU compute complex.

The AC provides high bandwidth D2D interfaces to connect independent accelerator and IO tiles, e.g., Flow Classification, Ethernet IO, encryption/decryption accelerators, compression/decompression accelerators, AI or media accelerators, etc. Such disaggregation enables these tiles to be developed in a relatively unconstrained manner, allowing them to scale in area to meet the increasing performance needs of the Beyond 5G (B5G) roadmap. Additionally, these IPs may connect using protocols such as CXL (Compute Express Link), Universal Chiplet Interconnect Express (UCIe), or Advanced eXtensible Interface (AXI) that may provide the ability to scale bandwidth for memory access beyond PCIe specified limits for devices. Leveraging industry standard on-package IO for these D2D interfaces, e.g., AIB, allows integration of third-party IPs in these SoCs. On-package integration in this manner of such IPs provides a much lower latency and power efficient data movement as compared to discrete devices connected over short reach PCIe or other SERDES (serializer/deserializer) interfaces. Additionally, the disaggregated IP tiles can be constructed in any process based on cost or any other considerations.

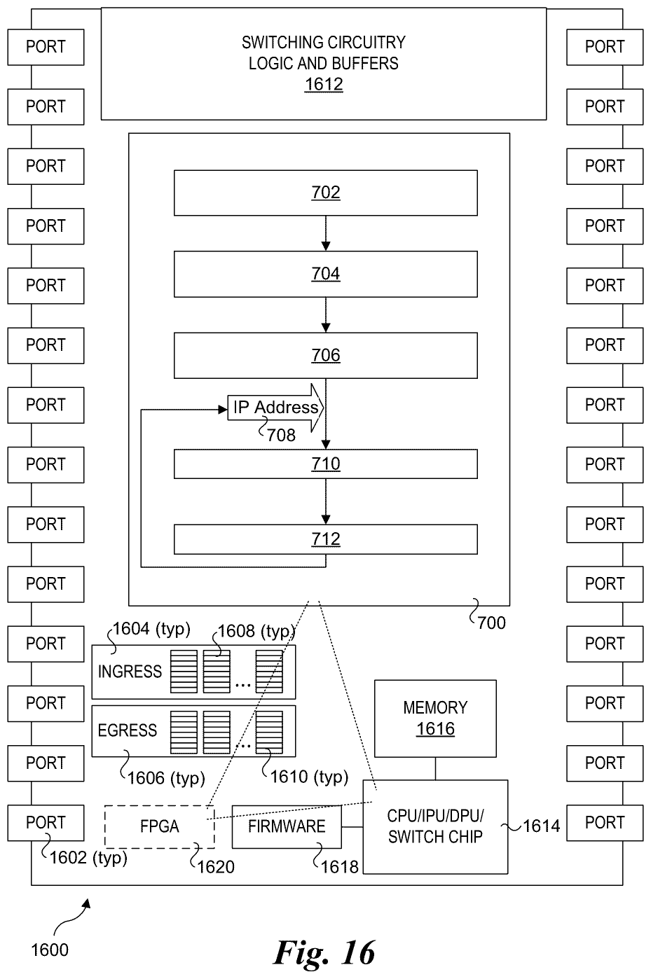

FIG. 16 shows a switch 1600 that may be implemented in some embodiments described and illustrated herein are implemented. Generally, switch 1600 employs conventional switch functionality while further adding the functionality employed by the embodiments disclosed herein. Accordingly, the description and illustrating of the conventional switch aspects are abstracted as the components and structures of conventional switches are well-known in the art and outside the scope of this disclosure.

Switch 1600 includes a plurality of IO ports 1602 that are configured to be coupled to a network or fabric. For example, if the network is an Ethernet network, IO ports 1602 are Ethernet ports and including circuitry for processing Ethernet traffic (e.g., Ethernet PHY and MAC circuitry). For a fabric, IO ports 1602 may employ applicable Host Fabric Interfaces (HFIs) or other types of fabric interfaces, noting that in the art the terms “network” and “fabric” are sometimes interchanged and have similar meaning. When switch 1600 is a CXL switch, IO ports 1602 are configured to support CXL interfaces and implement CXL protocols. When switch 1600 is a PCIe switch, IO ports 1602 are configured to support PCIe interfaces and implement PCIe protocols. Generally, IO ports 1602 may be configured to support networks or fabrics employing wired links (e.g., wired cable links or electoral traces on a printed circuit board or integrated circuit) or optical fiber links. In the latter case, IO ports 1602 may further include optical modules (not shown for simplicity).

In the illustrated embodiment, each IO port 1602 includes a set of ingress buffers 1604 and egress buffers 1606 (only one pair of which is shown for simplicity). The ingress and egress buffers may employ multiple receive queues 1608 and transit queues 1610. In one embodiment, switch 1600 supports QoS using different traffic classes, where some queues are allocated for different QoS levels (such as prioritized traffic associated with high bandwidth data). In some embodiments, one or more of the IO ports may have different structures and interfaces and may employ different protocols. For example, one or more ports may be used to connect to a management network or orchestrator.

The operation of switching functionality and associated ingress and egress buffer utilization is collectively shown via a switching circuitry logic and buffers block 1612. This would include, among other circuitry, switchable crossbar circuitry or the like to facilitate transfer of data from queues in ingress buffers to queues in egress buffers. It is noted the configuration of the ingress and egress buffers is illustrative and non-limiting. As is known in the art, there will be relatively small ingress and egress buffers at each IO port and there may either be separate ingress and egress buffers or separate shared buffers in memory on the switch. Generally, the actual packets are not buffered in the ingress and egress queues but rather these queues contain packet metadata along with a pointer to where the packet associated with the packet metadata for a given packet is buffered in memory. In this case, metadata, such as packet headers may be inspected and, optionally, updated, and the metadata are effectively moved between ingress and egress queues by copying the metadata from an ingress queue to an egress queue. Subsequently, the metadata that were copied will be overwritten by metadata for new received packets in the ingress queue.

Switching circuitry logic and buffers block 1612 may also include logic for implementing Layer 3 and above functionality, in some embodiments (such as traffic classification for QoS and other purposes, detecting invalid packets, etc.). As further shown, switch 1600 includes circuitry and logic for implementing the operations in flowchart 700 illustrated in FIG. 7 as discussed above.

The various logic and data structures shown and described herein may be implemented on a switch using appropriate embedded logic and circuitry. Such embedded logic may be implemented via execution of software/firmware on one or more processing elements, implementation of hardware-based logic such as preprogrammed logic (e.g., ASICs) and/or programmable logic (e.g., one or more FPGAs), or a combination of the two. In one embodiment, switch 1600 includes one or more CPUs or SoCs coupled to memory. In one embodiment, switch 1600 employs an IPU or DPU SoC chip that includes a plurality of processor cores in combination with FPGA circuitry. In addition, there is switch circuitry produced by various manufacturers such as switch chips that may be used for the conventional switching aspects of switch 1600. In one embodiment, CPU or SoC 1614 comprises a switch chip that implements the functionality ascribed to the logic for flowchart 700 in addition to conventional switch chip functionality.

In the illustrated example, switch 1600 includes a CPU/IPU/DPU/Switch Chip 1614 coupled to memory 1616 and a firmware storage device 1618. Switch 1600 may also include an FPGA 1620 in some embodiments. In cases where CPU/IPU/DPU/Switch Chip 1614 is an IPU or DPU, the IPU or DPU may include one or more embedded FPGAs. In one embodiment, the IPU is an Intel® IPU, such as but not limited to a Mount Evans IPU chip, which includes a multi-core CPU, on-chip memory controllers, and an FPGA that may be programmed for performing various packet processing operations.

Firmware storage device 1618 stores firmware instructions/modules that are executed on one or more cores in CPU/IPU/DPU/Switch Chip 1614 to effect the functionality of all or a portion of logic for flowchart 700. The firmware instructions are loaded into memory 1616 and executed, with applicable data structures data structures being stored in memory 1616. Optional FPGA 1620 may also be programmed to implement the functionality (in whole or in part) of the logic for flowchart 700.

### Exemplary Use Cases

The principles and techniques disclosed herein generally may be applied to any application that performs ternary key matching at large scales. For instance, consider packet classification. A network forwarding element (e.g., switch/router) or network edge appliance may need to support hundreds of thousands or even millions of flows. Each flow can be identified by information contained in the packets using an m-tuple key, where a tuple is a header field and m≥1. Depending on the implementation, flow classification may require a single tuple (such as an IP destination address for a forwarding application that employs longest prefix match (LPM) or may employ multiple tuples (such as a 5-tuple match). Additional non-limiting example uses include traffic policing and filtering in gateways and other appliances (e.g., action control list (ACL) implementations), and deep packet inspection for security applications.

Other non-limiting examples of use cases include Bioinformatics (e.g., DNA sequencing, etc.), Artificial Intelligence (AI), and machine learning. The techniques and principles may also be applied to searching large datasets that use ternary indexing and for building ternary search trees that may be used for a variety of applications.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems, the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

As used herein, an “engine” is some means for performing one or more of the operations described and/or illustrated above. Generally, an engine may be implemented in software (e.g., instructions executed on a processing element such as a processor core), in hardware (e.g., logic implemented in one or more of a FPGA, ASIC, or other programmable logic device), or a combination of software and hardware. In one aspect of a software-based implementation, respective sets of instructions are executed on respective cores in a multi-core CPU/processor/SoC. The instructions in a set of instructions may be implemented as one or more threads or processes. In some hardware-based embodiments, each engine is implemented as a respective block of logic (or associative blocks of logic).

While some of the diagrams show numbered operations, the use of numbers is for ease of explanation and does not imply the operations must be performed in the numbered order, although they may be performed in the numbered order is some embodiments. In other embodiments, the order of the operations may be changed. Additionally, in some embodiments, multiple operations may be performed in parallel (concurrently) or substantially concurrently.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (e.g., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A graph-based method for performing a longest prefix match (LPM), comprising:
creating a plurality of ternary keys, each representing an Internet Protocol (IP) address prefix and having a length w and a corresponding number of specified bits comprising a prefix length followed by one or more wildcards;
partitioning the plurality of ternary keys into a plurality of subsets as a function of the prefix lengths of the ternary keys;
for each subset,
constructing a graph;
storing the graph in memory;
searching the graphs for a match for an IP address; and
returning a result associated with a match from a graph associated with the subset of prefixes with the longest prefix length.

2. The method of claim 1, wherein the plurality of ternary keys are partitioned into the plurality of subsets based on a statistical distribution of the prefix lengths.

3. The method of claim 1, wherein at least a portion of the graphs comprise single node space graphs, wherein searching a single node space graph only requires processing a single graph node.

4. The method of claim 1, wherein each graph is associated with a prefix length interval, constituting a subset of a partition of a prefix length space.

5. The method of claim 1, wherein the graphs are stored in memory as a plurality of sub-tables that are configured to be searched in parallel using a graph memory engine.

6. The method of claim 5, wherein the graph memory engine includes search logic programmed in pre-programmed or programmable hardware logic.

7. The method of claim 5, wherein the graph memory engine includes search logic programmed in a Field Programmable Gate Array (FPGA) associated with the memory.

8. The method of claim 1, further comprising:
specifying a number of partitions;
determining a statistical distribution of prefix lengths; and
based on the number of specified partitions and the statistical distribution of prefix lengths, computing a prefix length partition with a minimum cost using an associated cost function.

9. A non-transitory machine-readable medium having instructions stored thereon configured to be executed on one or more processing elements in a computing apparatus having memory, wherein execution of the instructions on the one or more processing elements enables the computing apparatus to:
access a plurality of ternary keys, each representing an Internet Protocol (IP) address prefix and having a length w and a corresponding number of specified bits comprising a prefix length following by one or more wildcards;
partition the plurality of ternary keys into a plurality of subsets as a function of the prefix lengths of the ternary keys;
for each subset,
construct a graph;
store the graph in memory;
search the graphs for a match for an IP address; and
return a result associated with a match from a graph associated with the subset of prefixes with the longest prefix length.

10. The non-transitory machine-readable medium of claim 9, wherein the plurality of ternary keys are partitioned into the plurality of subsets based on a statistical distribution of the prefix lengths.

11. The non-transitory machine-readable medium of claim 9, wherein at least a portion of the graphs comprise single node space graphs, wherein searching a single node space graph only requires processing a single graph node.

12. The non-transitory machine-readable medium of claim 9, wherein each graph is associated with a prefix length interval, constituting a subset of a partition of a prefix length space.

13. The non-transitory machine-readable medium of claim 9, wherein execution of the instructions further enables the computing apparatus to:
store the graphs in memory as a plurality of sub-tables; and
search the sub-tables in parallel.

14. The non-transitory machine-readable medium of claim 13, wherein the sub-tables are searched in parallel using a graph memory engine.

15. The non-transitory machine-readable medium of claim 14, wherein the graph memory engine includes search logic programmed in pre-programmed or programmable hardware logic in the computing apparatus.

16. The non-transitory machine-readable medium of claim 9, wherein execution of the instructions further enables the computing apparatus to:
access a specified number of partitions;
determine a statistical distribution of prefix lengths; and
based on the number of specified partitions and the statistical distribution of prefix lengths, compute a prefix length partition with a minimum cost using an associated cost function.

17. An apparatus comprising:
memory; and
means for performing a longest prefix match (LPM) by,
accessing a plurality of ternary keys stored in memory, each representing an Internet Protocol (IP) address prefix and having a length w and a corresponding number of specified bits comprising a prefix length following by one or more wildcards;
partitioning the plurality of ternary keys into a plurality of subsets as a function of the prefix lengths of the ternary keys;
for each subset,
constructing a graph;
storing the graph in memory;
searching the graphs for a match for an IP address; and
returning a result associated with a match from a graph associated with the subset of prefixes with the longest prefix length.

18. The apparatus of claim 17, wherein the means for performing the LPM comprises one or more programmable or preprogrammed logic components comprising one or more of a Field Programmable Gate Array (FPGA), and Application Specific Integrated Circuit (ASIC), and a programmable logic device.

19. The apparatus of claim 18, wherein the apparatus comprises an infrastructure processing unit (IPU), a data processing unit (DPU), an edge processing unit (EPU), a router, or a switch.

20. The apparatus of claim 17, wherein the means for performing the LPM comprises:
one or more processing elements coupled to memory and instructions configured to be executed on the one or more processing elements; and
one or more programmable or preprogrammed logic components comprising one or more of a Field Programmable Gate Array (FPGA), and Application Specific Integrated Circuit (ASIC), and a programmable logic device.
